(19) United States
(12) Patent Application Publication
(10) Pub. No.: US 2013/0103413 A1
(43) Pub. Date: Apr. 25, 2013

(54) PROMOTING PHARMACEUTICAL PRODUCTS

(71) Applicant: Farouk Meralli, Dubai (AE)

(72) Inventor: Farouk Meralli, Dubai (AE)

(21) Appl. No.: 13/450,013

(22) Filed: Apr. 18, 2012

Related U.S. Application Data
(63) Continuation-in-part of application No. 13/278,808, filed on Oct. 21, 2011.

(51) Int. Cl. G06Q 50/22

(52) U.S. Cl. 705/2

(57) ABSTRACT

Among other things, an association is maintained between a promotional campaign for a product (such as a pharmaceutical product) and an identifier that is unique with respect to at least one of the campaign, the product, or a stakeholder associated with the product. In association with the unique identifier, information is stored about at least one of the following: the campaign, the product, the stakeholder, or activities of the stakeholder with respect to the product.

### RELATED APPLICATIONS

This application is a continuation-in-part of U.S. patent application Ser. No. 13/278,808, filed Oct. 21, 2011, the entire contents of which are incorporated here by reference.

### BACKGROUND

This description relates to promoting pharmaceutical products.

Traditional pharmaceutical product promotion by pharmaceutical manufacturers relies predominately on independent efforts targeted to an individual physician or retailer or patient. Generally, these and other parties who have an interest in such promotion are known, as stakeholders.

### SUMMARY

In general, in an aspect, an association is maintained between a promotional campaign for a product (such as a pharmaceutical product) and an identifier that is unique with respect to at least one of the campaign, the product, or a stakeholder associated with the product. In association with the unique identifier, information is stored about at least one of the following: the campaign, the product, the stakeholder, or activities of the stakeholder with respect to the product.

Implementations may include one or more of the following features. The stakeholder includes at least one of an end user of the product, a physician who prescribes or recommends the product, a manufacturer of the product, or a retailer of the product. The unique identifier is provided to a stakeholder who is an end user of the product. The unique identifier is provided to the end user by the end user's physician or by a retailer that serves the end user or both. The information about the activities of the stakeholder is provided from a mobile device of the stakeholder. The information is stored, in association with the unique identifier, about activities of multiple stakeholders with respect to the product. The unique identifier is associated with attributes of the associated campaign. The stored information is analyzed with respect to the campaign. The stored information is analyzed with respect to at least one other campaign. Actionable attributes of the campaign are carried out. The actionable attributes include at least one of customized communications, timed refill reminders, retailer rebates, or end user discounts. Reports are provided based on the stored information. The information includes responses of the stakeholder. Messages are sent to the stakeholder. The messages include information including at least one of safety and efficacy of the product, affordability features of the product, discounts, promotions, coupons, rebates, medication adherence, education programs, and drug interactions. The messages include customized communications or discounts that are based on relationships of the product to other products. A sequence of activities with respect to the product is tracked. The activities of the sequence include at least one of product recommendation or prescription by a physician, dispensing of the product to the end user, and use of the product by the end user. The attributes of the campaign include geography.

In general, in an aspect, an apparatus includes a processor to maintain an association between a promotional campaign for a pharmaceutical product and an identifier that is unique with respect to at least one of the campaign, the product, or a stakeholder associated with the product. Storage holds, in association with the unique identifier, information about at least one of the following: the campaign, the product, the stakeholder, or activities of the stakeholder with respect to the product.

In general, in an aspect, an apparatus includes means for maintaining an association between a promotional campaign for a pharmaceutical product, and an identifier that is unique with respect to at least one of the campaign, the product, or a stakeholder associated with the product, and means for storing, in association with the unique identifier, information about at least one of the following: the campaign, the product, the stakeholder, or activities of the stakeholder with respect to the product.

In general, in an aspect, a computer-implemented method includes, with respect to a promotional campaign for a pharmaceutical product, sending messages to mobile devices of stakeholders associated with the product, the messages being based on actionable attributes of the campaign and identified based on a unique identifier associated with the campaign.

Implementations may include one or more of the following features. The stakeholder can associate a mobile phone number belonging to a stakeholder with a campaign. The stakeholder can associate a mobile phone number belonging to another stakeholder with a campaign. The unique user identifier provided to the end user is linked with the mobile number of the end user. The unique identifier is provided to the end user verbally, in paper form, or by an online system, interactive voice response program, or other computer assisted system. The information is stored by a stakeholder in association with a unique identifier associated with at least one of the end user's gender, age, address, physician's name, physician's location, or other demographic data. The information is stored by a stakeholder in association with end user's mobile phone number associated with at least one of the end user's gender, age, address, physician's name, physician's location, or other demographic data. The stakeholder enters the end user's information using a mobile phone, digital camera, or scanner and takes a photo or image of the end user's prescription and sends it to the system. Information is stored by a stakeholder in association with a unique identifier associated with at least one of a physician's company name, office name, mobile phone number or numbers, address, physician or other related stakeholder names, or sales representative or sales representative information. The information is stored by a stakeholder in association with an end user's mobile phone number associated with at least one of a physician's company name, office name, mobile phone number or numbers, address, physician or other related stakeholder names, or sales representative or sales representative information. The messages sent to a first stakeholder are sent on behalf of a second stakeholder. The messages sent include an indicator that a second stakeholder is a source of the messages. Indications are received that prescriptions have been filled for an end user. The indications include at least one of a detailed invoice record, a registration card filled by the end user and kept by the retailer, or a part of the packaging being kept by the retailer. The indications are associated with at least one of the tracking of a number of products or services that can be purchased at any given time or over a certain time period by an end user, the restricting of mobile numbers of retailers from purchase, or the requiring of a confirmation text from an end-user. The actionable attribute includes at least one of mobile minutes or airtime, loyalty points, miles or other reward. The actionable attribute is stored and acted on at a later time. The mobile number is linked to one or more additional mobile numbers. The activity of stakeholders is monitored, and the stakeholder is sent an automated reminder prompt when messages sent to the system are low. The messages include requests to purchase quantities of the product.

In general, in an aspect, a number is recorded of visits made to physicians by sales representatives to solicit participation in a system (in which an association is maintained between a promotional campaign for a pharmaceutical product and an identifier that is unique with respect to at least one of the campaign, the product, or a stakeholder associated with the product). In association with the unique identifier, information is stored about at least one of the following: the campaign, the product, the stakeholder, or activities of the stakeholder with respect to the product. In some implementations, the number of physician or retailer enrollments per sales representative is tracked.

Implementations may include one or more of the following features. An association is maintained between the promotional campaign and individual product labels containing unique product label codes. The actionable attribute is in response to additional information supplied by a stakeholder. The stored actionable attribute is delivered in response to a generated unique discount identifier. Information is stored by a stakeholder in association with an end user's mobile phone number associated with at least one of the end user's gender, age, address, physician's name, physician's location, or other demographic data. Information is stored by a stakeholder in association with an end user's mobile phone number associated with at least one of a physician's company name, office name, mobile phone number or numbers, address, physician or other related stakeholder names, or sales representative or sales representative information.

In general, in an aspect, an association is maintained between a promotional campaign for a pharmaceutical product and an identifier that is unique with respect to at least one of the campaign, the product, or a stakeholder associated with the product. Information is received about a health status of an end user who is a participant in the promotional campaign and is using the pharmaceutical product. The received information is linked to the end user's use of the pharmaceutical product.

Implementations may include one or more of the following features. The information received about the end user comprises laboratory results, diagnostic information, or health outcomes or any two or more of them. Graphical information and data is exposed to stakeholders in the promotional campaign reporting information received from the end user and information related to the end user's use of the pharmaceutical product. The graphical information and data is exposed to the stakeholders through an SMS, text, IVR, telephone, or online interactive system. The information about the end user's health status is received from the end user. The information is received from a stakeholder other than the end user. The information is received in reply to queries from the system.

These and other aspects, features, and implementations can be expressed as methods, program products, apparatus, systems, components, user interfaces, databases, means or steps for performing functions, and in other ways.

Other aspects, features, and implementations will become apparent from the following description and from the claims.

### DESCRIPTION

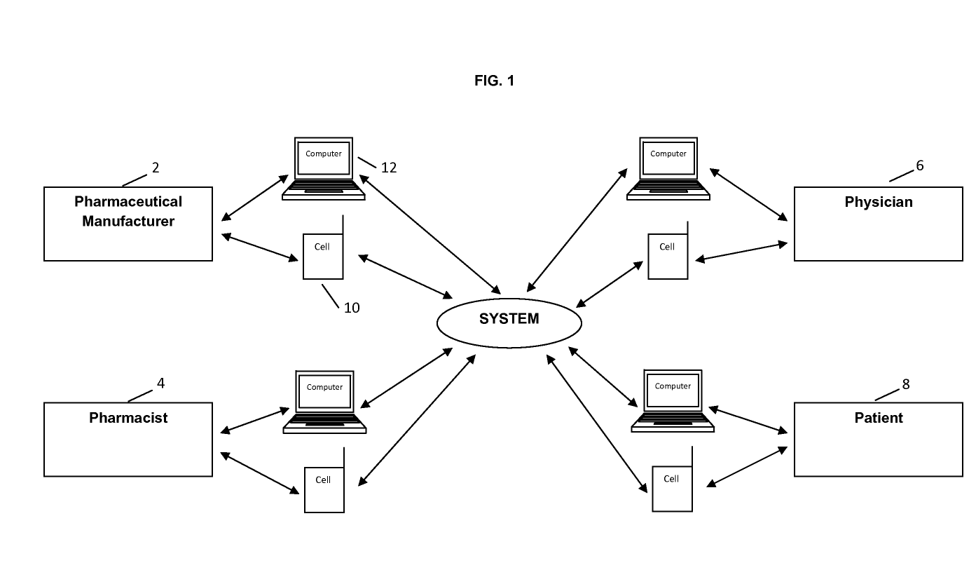

FIG. 1 is a diagram representing primary stakeholders that interact with a promotion management system and the devices they use to interact with the promotional campaign management system (which is an example of what we sometimes refer to as simply the system).

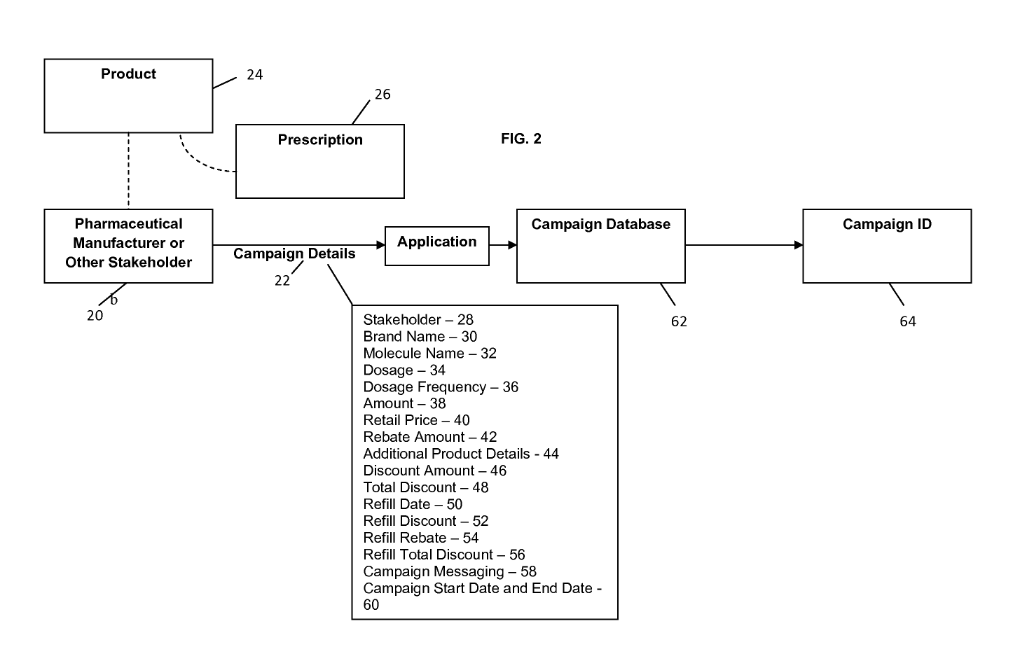

FIG. 2 is a diagram showing an example process of associating attributes of a pharmaceutical product promotional campaign with a unique identifier (that we sometimes refer to, for example, as a campaign ID).

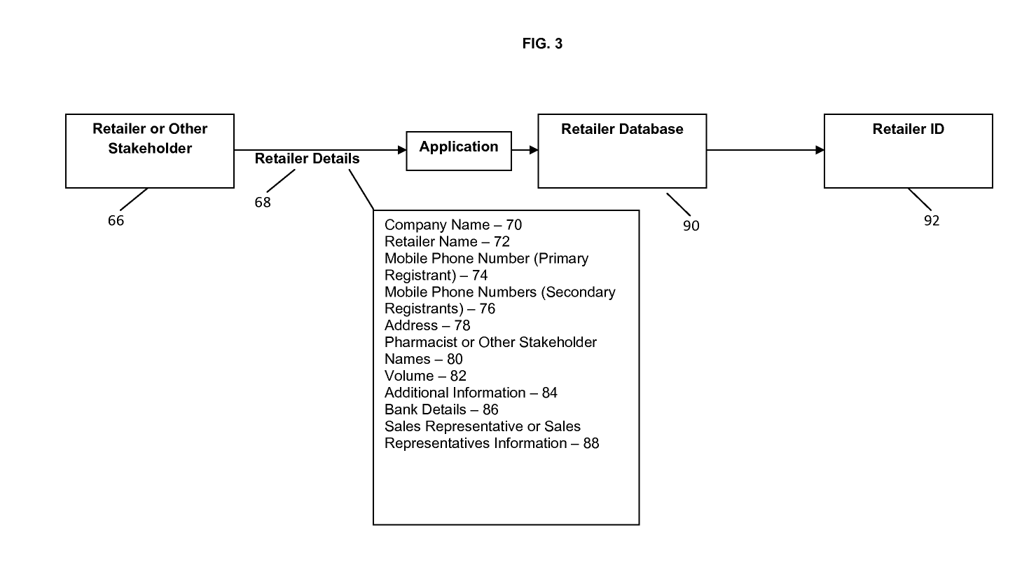

FIG. 3 is a diagram showing an example process of associating attributes of a pharmaceutical retailer with a unique identifier (that we sometimes refer to, for example, as a retailer ID).

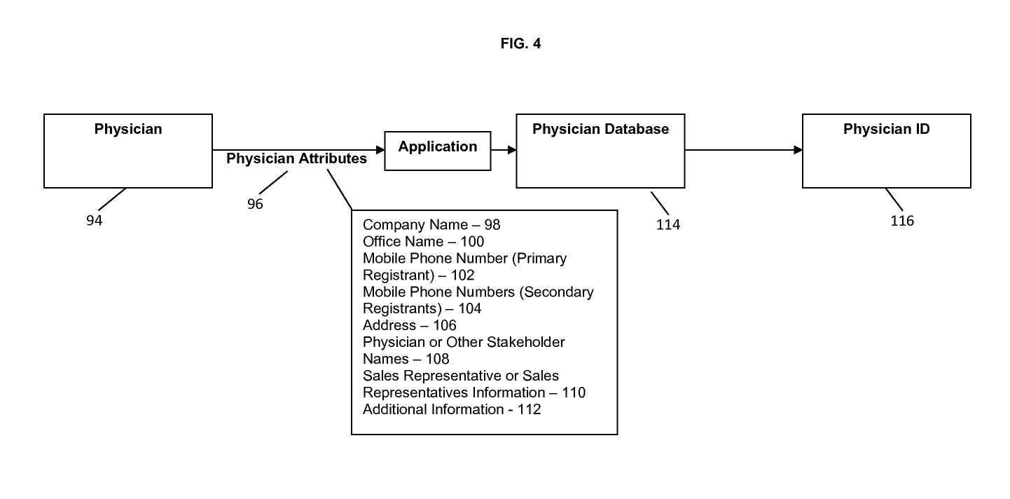

FIG. 4 is a diagram showing an example process of associating attributes of a particular physician with a unique identifier (that we sometimes refer to, for example, as a physician ID).

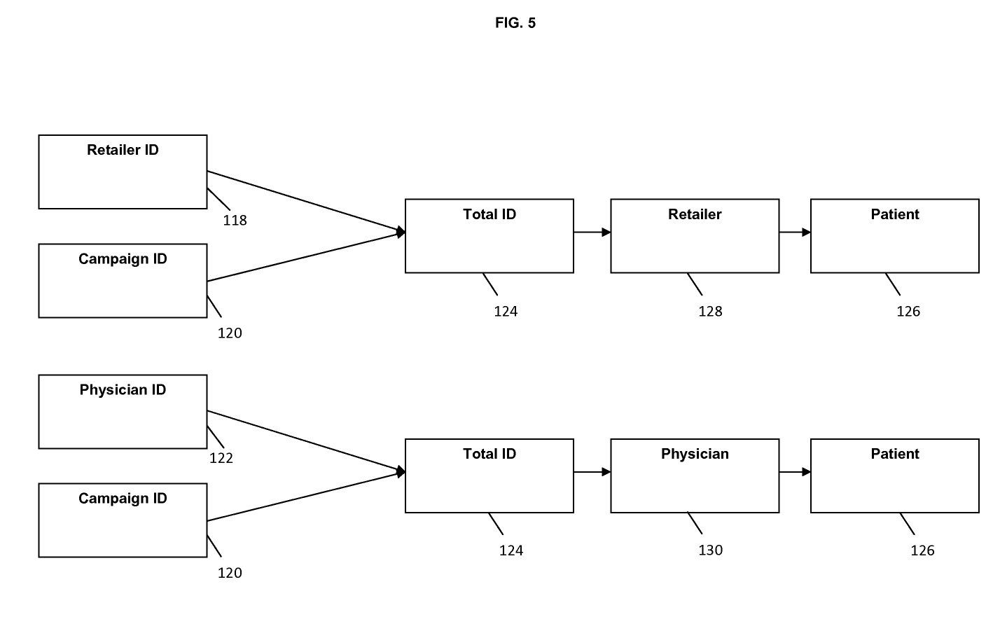

FIG. 5 is a diagram showing an example process of linking a retailer ID to a campaign ID and a physician ID to a campaign ID to create a unique identifier (that we sometimes refer to, for example, as a total ID).

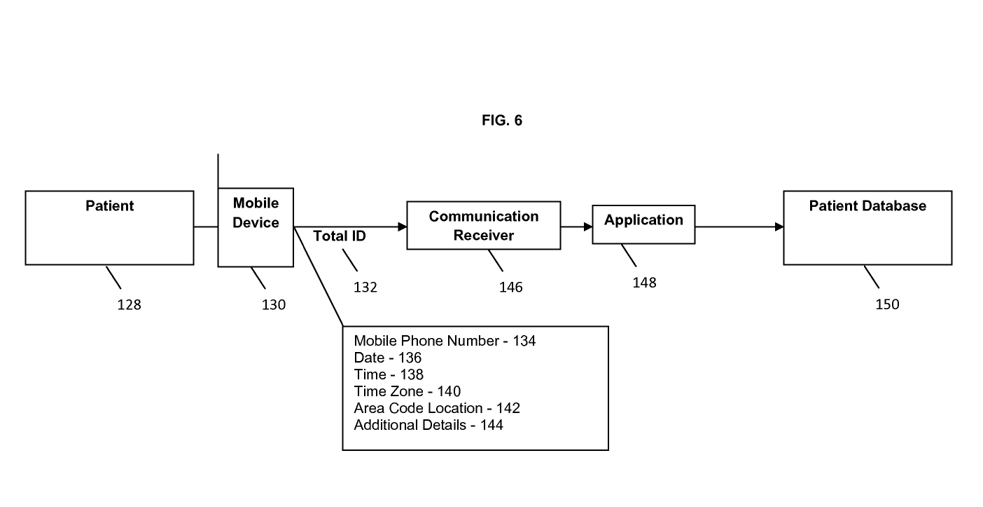

FIG. 6 is a diagram showing an example of how a patient sends a total ID to the system and how the collected information is received and stored by the system.

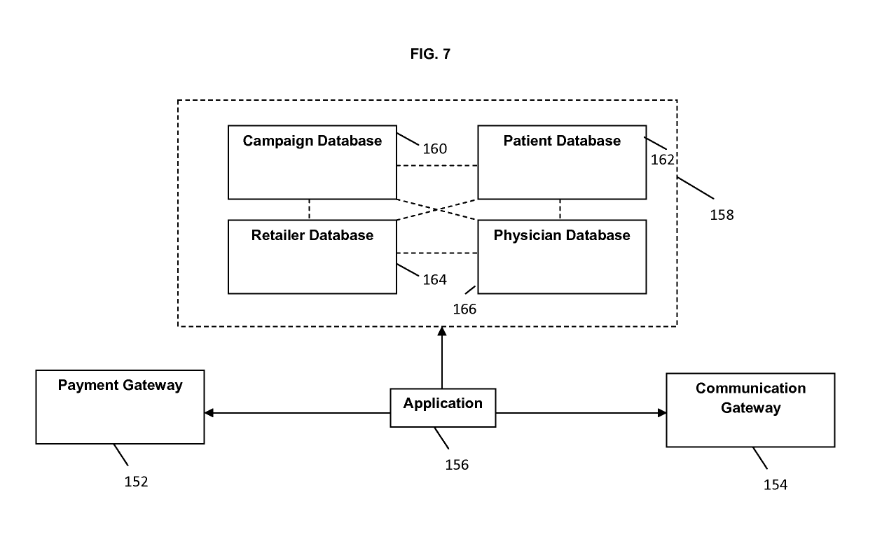

FIG. 7 is a diagram showing an example of how the system may be composed of various modules including a database, a banking gateway and a communication gateway.

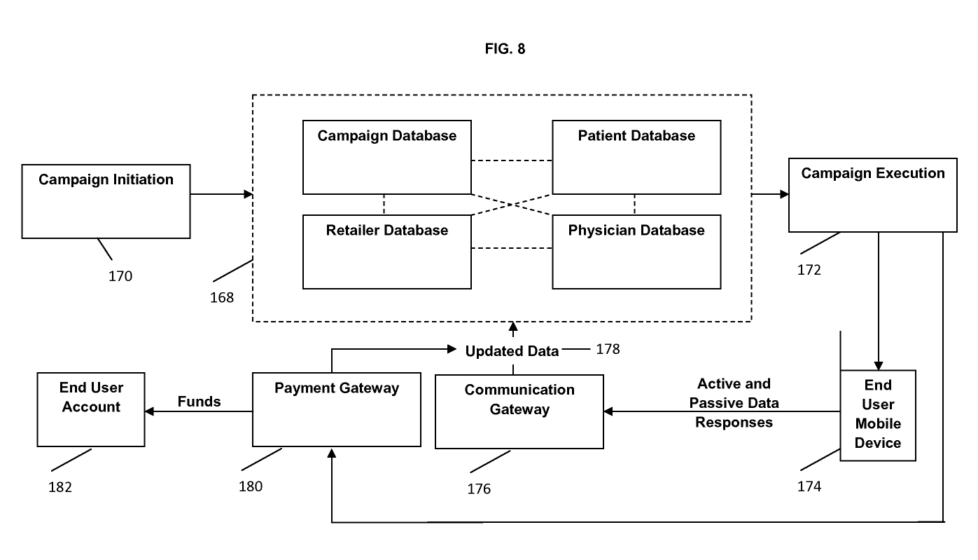

FIG. 8 is a diagram showing an example of how the system initiates and executes a campaign to various stakeholders and acts to passively and actively collect data to update stored information regarding pharmaceutical manufacturers, products, physicians, retailers and patients.

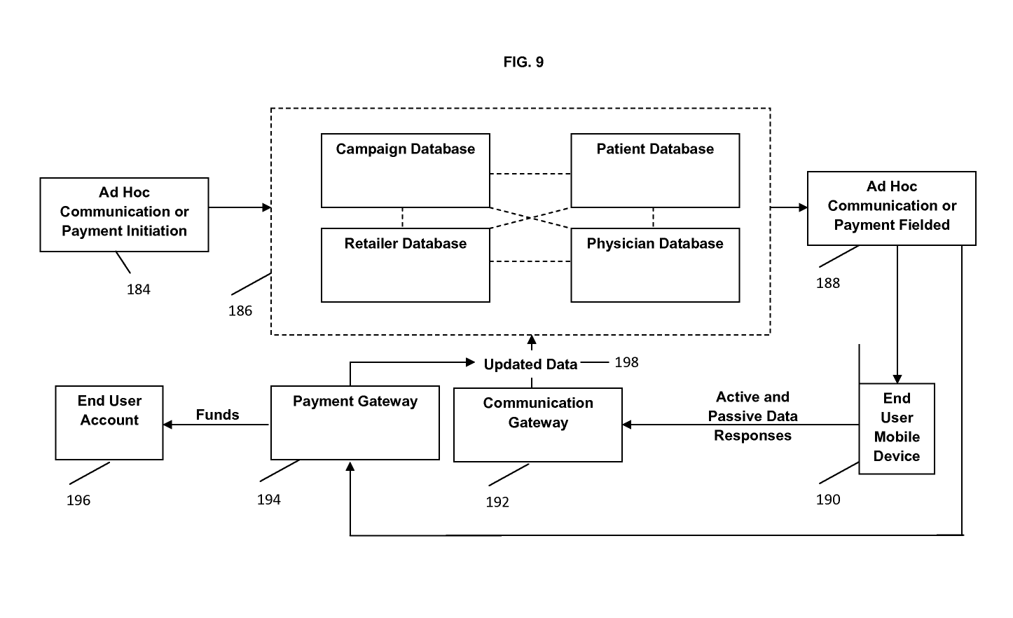

FIG. 9 is a diagram showing an example of how ad hoc messages can be initiated and executed to stakeholders and how responses can be passively and actively collected to update stored information regarding manufacturers, products, physicians, retailers, and patients.

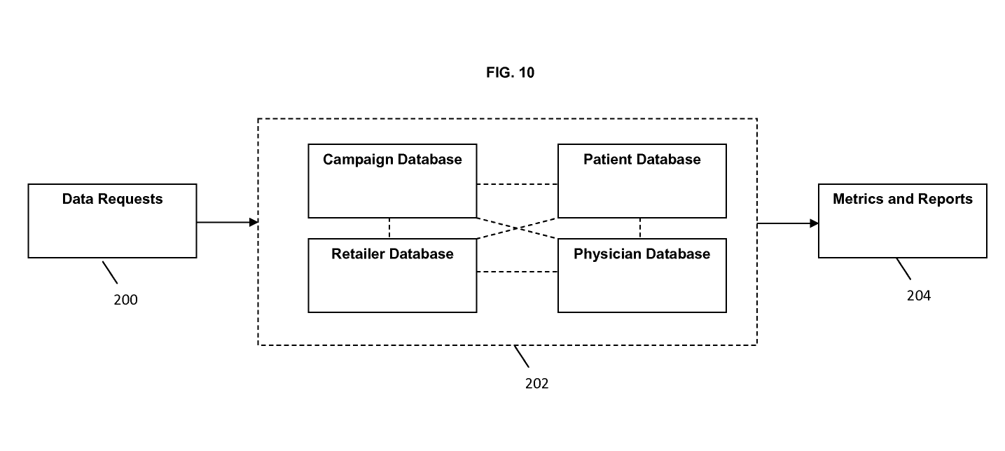

FIG. 10 is a diagram showing an example of how data stored within the system can be accessed and displayed through output formats such as metrics and reports.

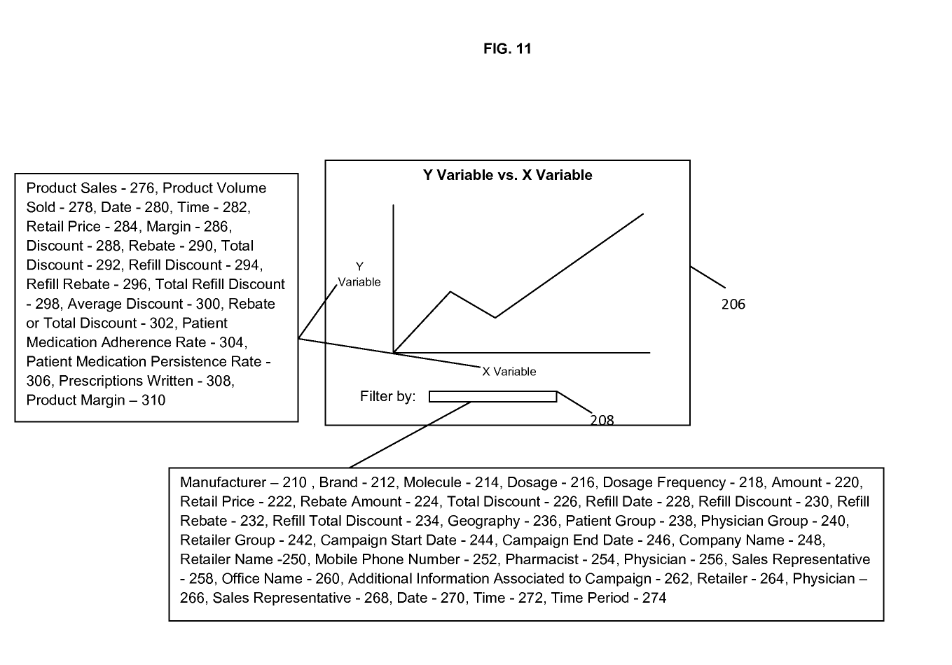

FIG. 11 is a diagram showing an example of how data variables stored in the system can be visualized in graphical form.

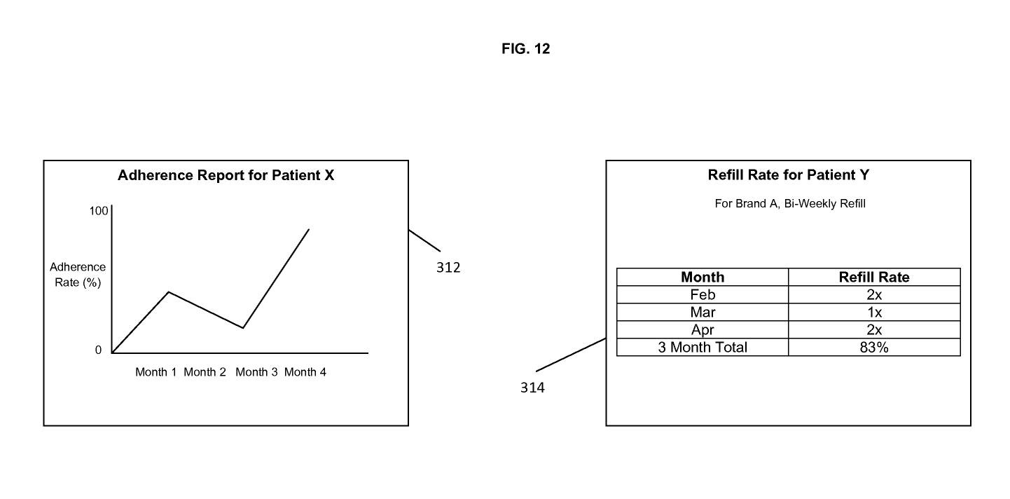

FIG. 12 is a diagram showing sample reports for the patient including an adherence report and a refill report.

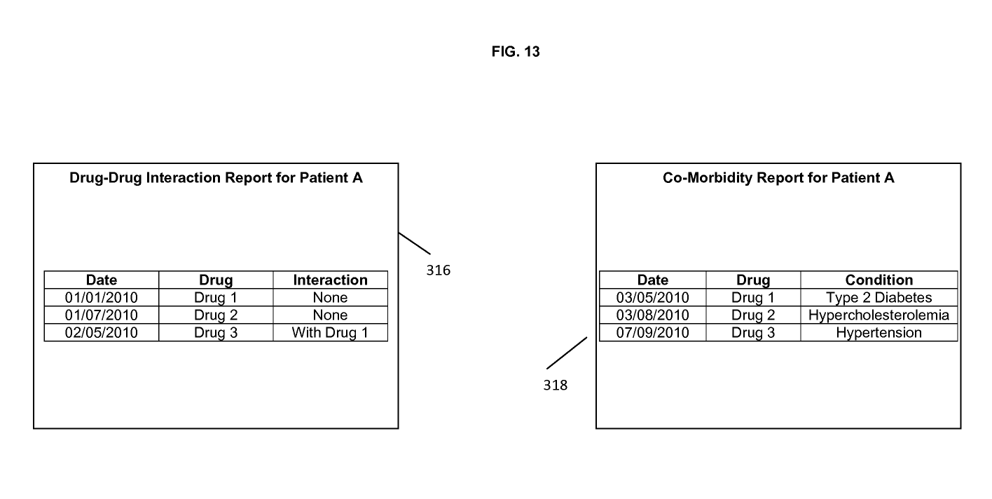

FIG. 13 is a diagram showing sample reports for the patient including a drug-drug interaction report and a co-morbidity report.

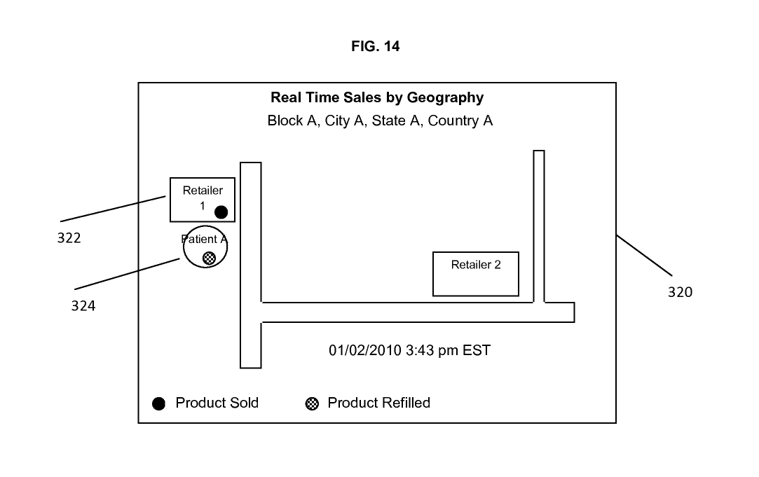

FIG. 14 is a diagram showing a sample visualization of real-time sales data across a specific geography.

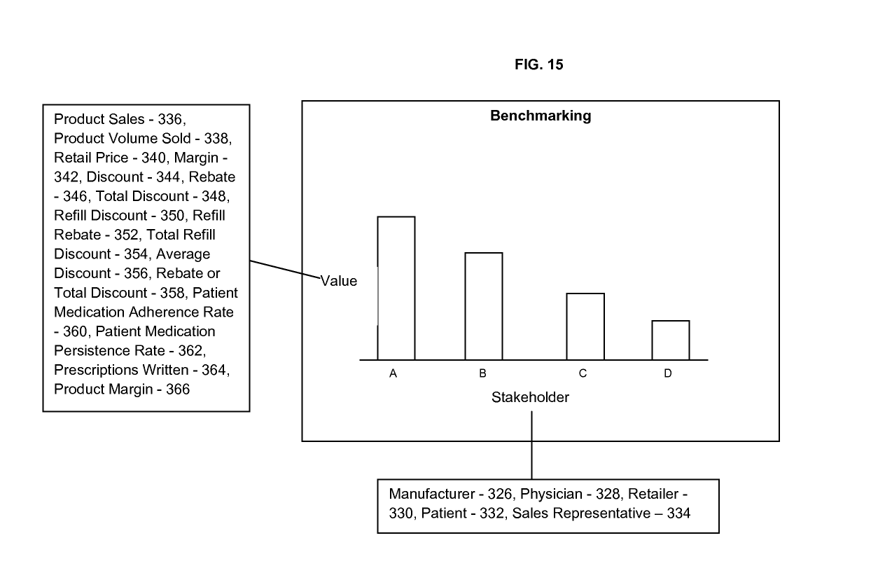

FIG. 15 is a diagram showing an example of how benchmarking between different stakeholders can be visualized.

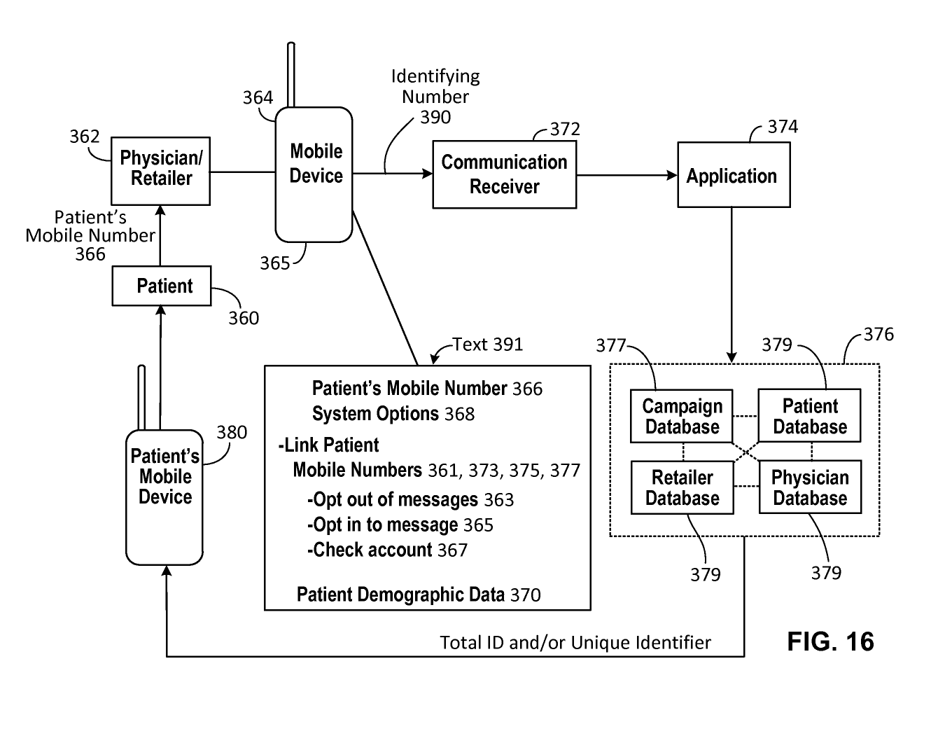

FIG. 16 is a diagram showing an example of how a stakeholder such as a physician or retailer can register a patient's mobile number to the system and perform other system functions on behalf of the patient without providing an identifying number to the patient.

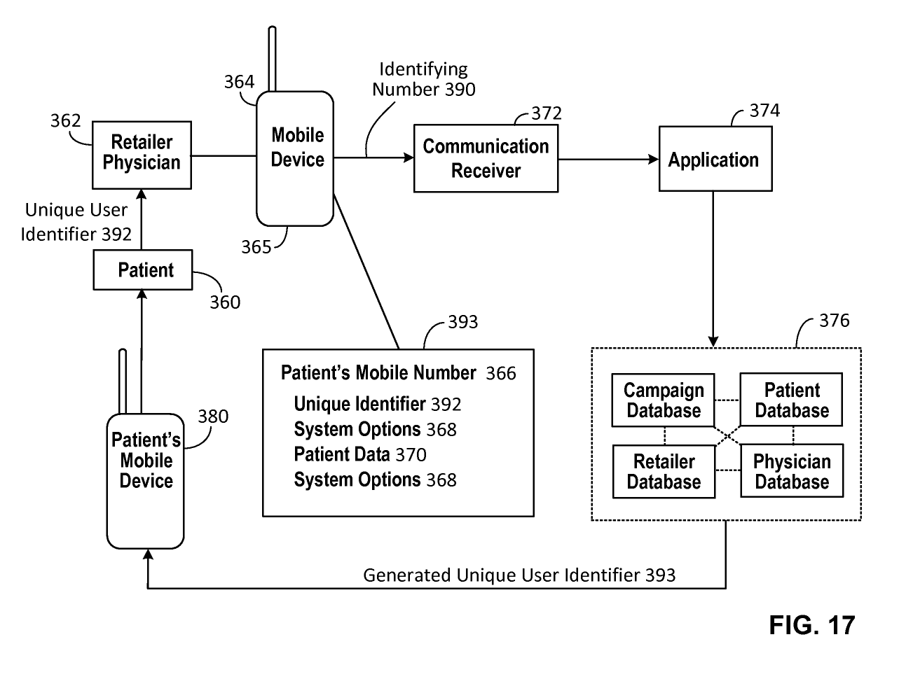

FIG. 17 is a diagram showing an example of how a stakeholder such as a physician or retailer can register a patient's mobile number to the system and perform other system functions on behalf of the patient by providing the patient with a unique user identifier that is linked to the patient's mobile phone number.

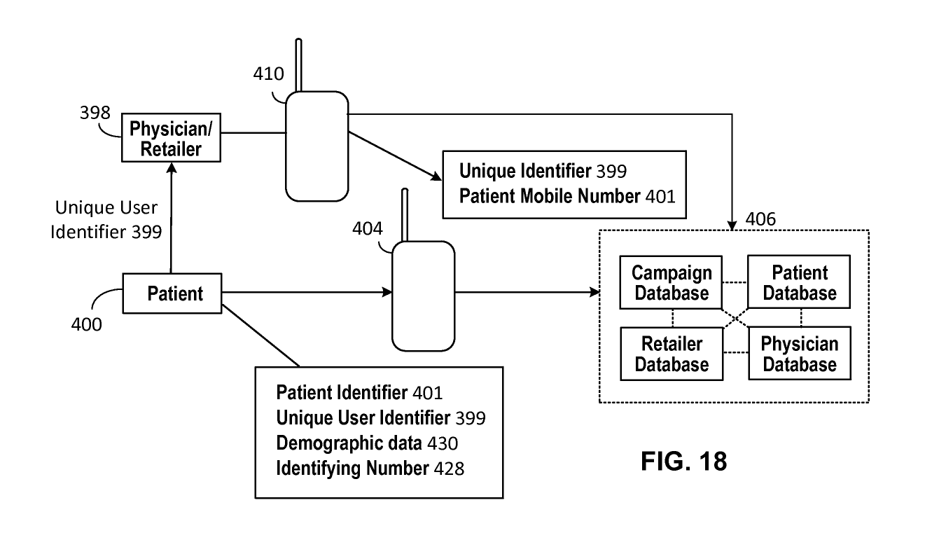

FIG. 18 is a diagram showing an example of how a patient can register the patient's mobile number to the system and perform other system functions using the patient's mobile phone.

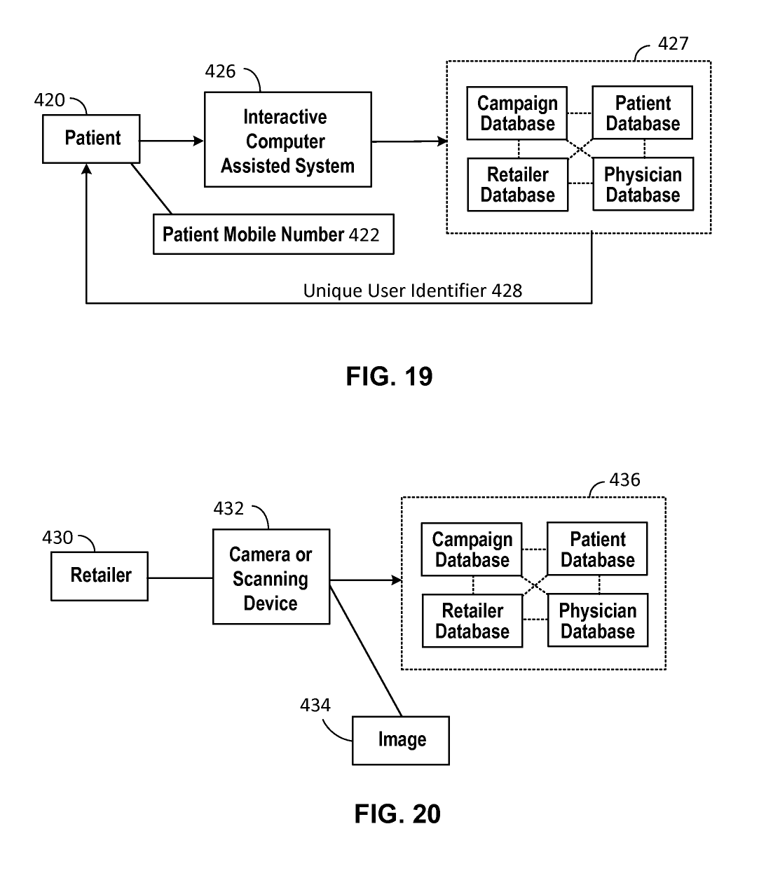

FIG. 19 is a diagram showing an example of how a patient can register the patient's mobile number to the system and perform other system functions using an interactive computer assisted system.

FIG. 20 is a diagram showing an example of how a stakeholder can send prescription information of a patient to the system using a camera or other scanning device.

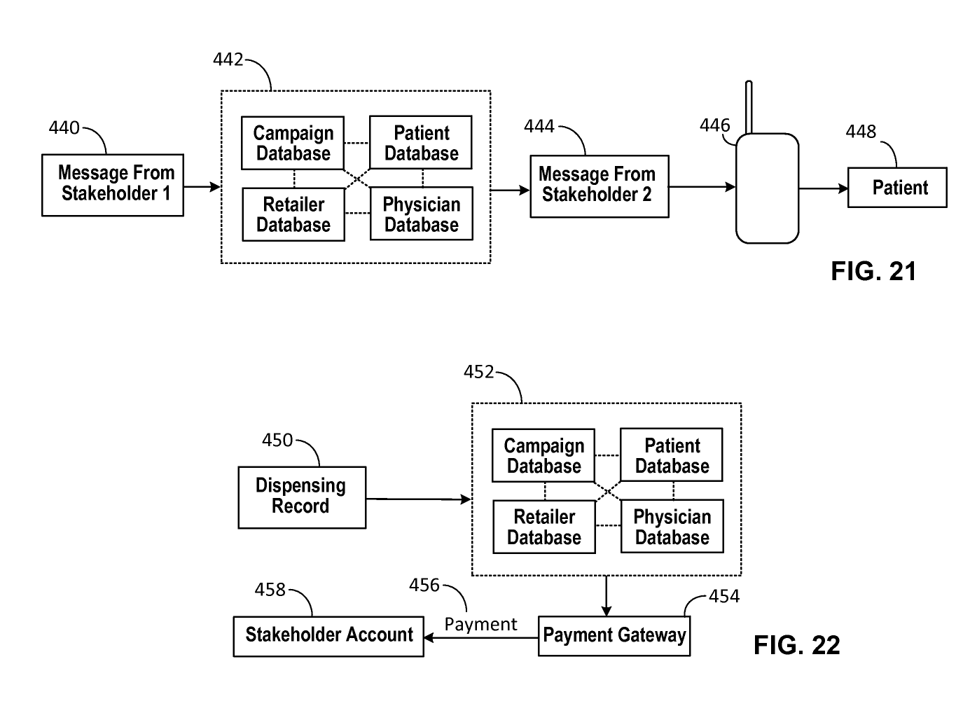

FIG. 21 is a diagram showing a message sent from a first stakeholder can be delivered to a patient on behalf of a second stakeholder.

FIG. 22 is a diagram showing an example of how a dispensing record can be reconciled with the system records before payment is delivered to an end user's account.

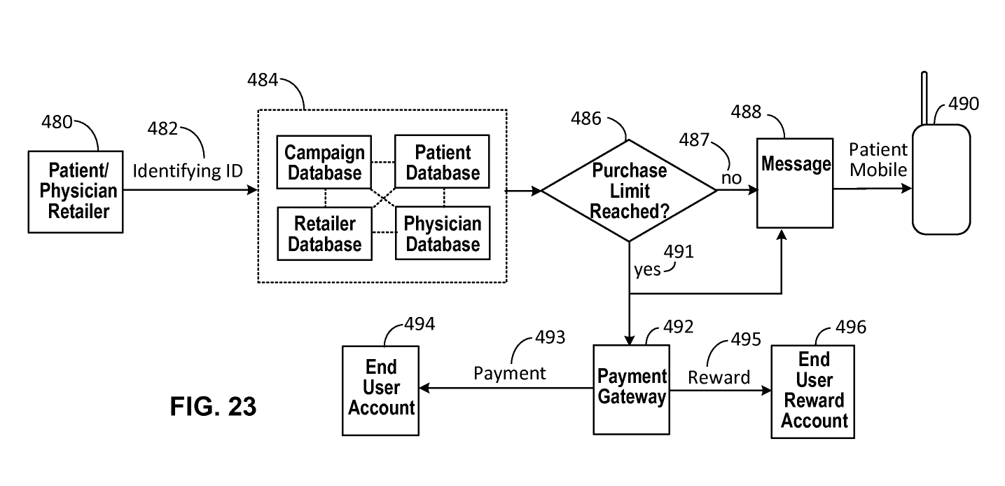

FIG. 23 is a diagram showing an example of how the system can record transactions from a stakeholder and take a payment or other reward action when a certain criteria is reached.

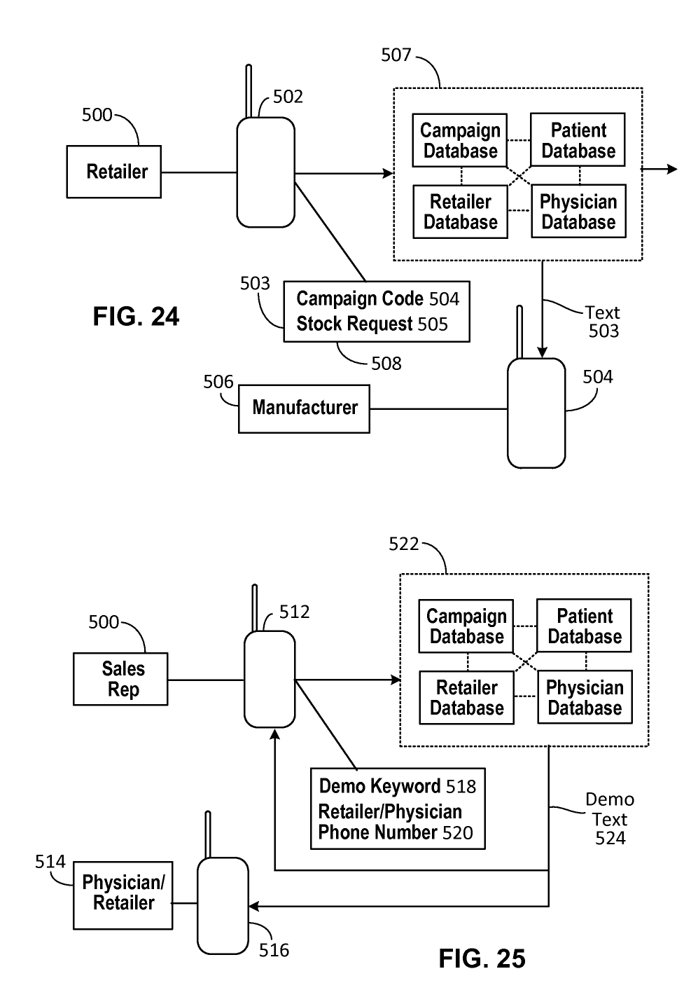

FIG. 24 is a diagram showing an example of how retailer can send a message to the system that automatically interprets the message and delivers it to an appropriate recipient.

FIG. 25 is a diagram showing an example of how the system be used by a sales representative in a demonstration and can record the number of demonstrations made by the sales representative.

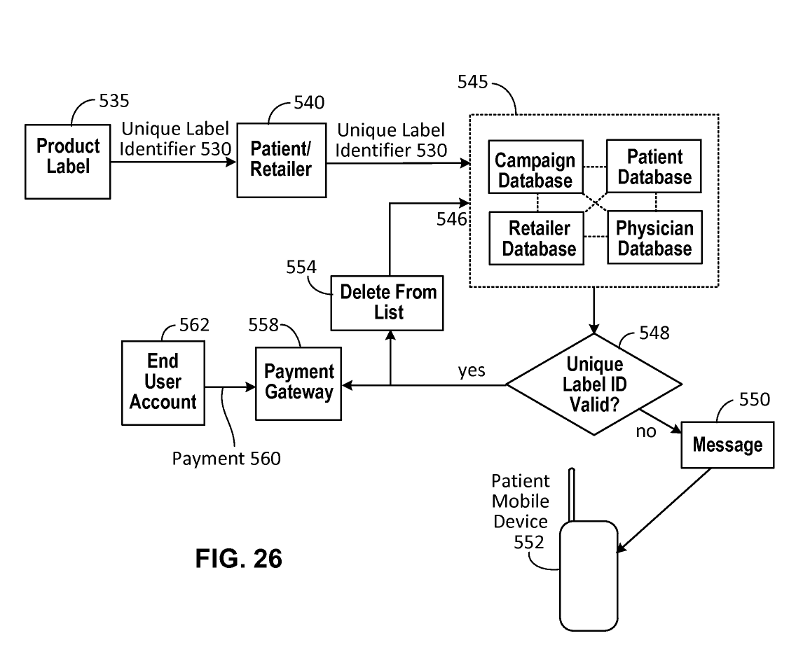

FIG. 26 is a diagram showing an example of how a unique label identifier can be used to validate an end user payment.

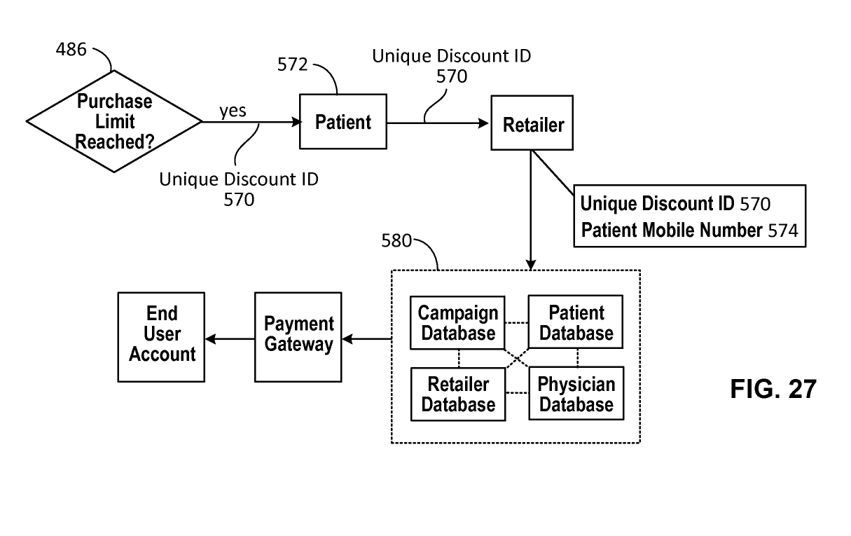

FIG. 27 is a diagram showing an example of how a unique discount ID can be supplied to an end user.

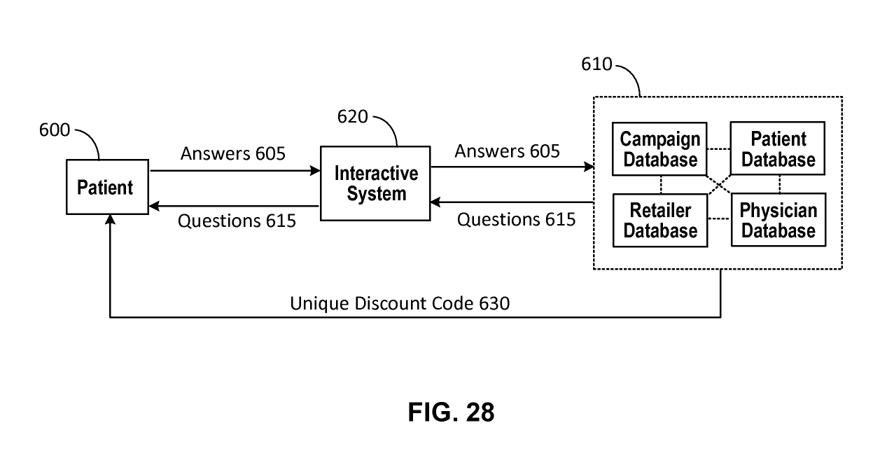

FIG. 28 is a diagram showing an example of how a discount can be provided to an end user in response to answering system questions.

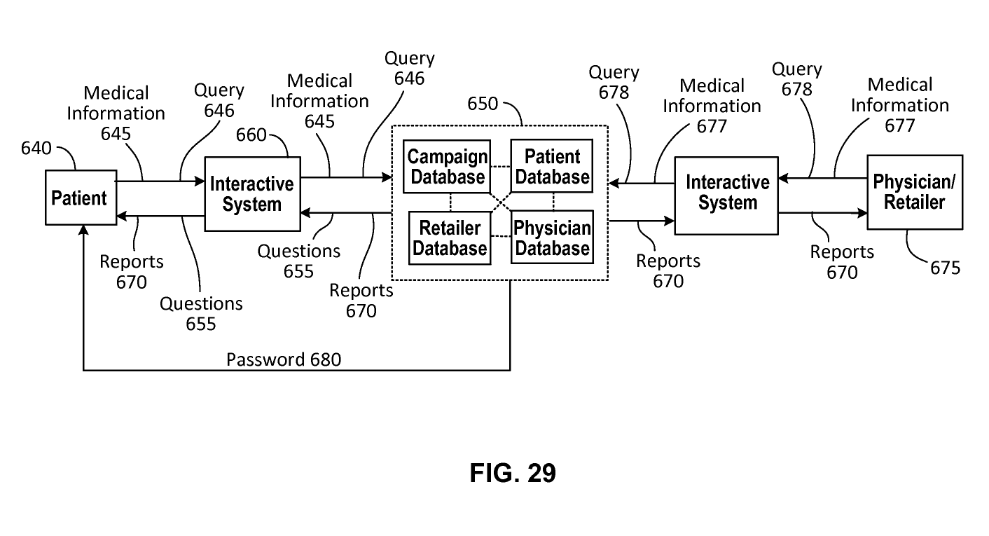

FIG. 29 is a diagram showing an example of how a patient or other stakeholder can provide and receive reports of requested medical information.

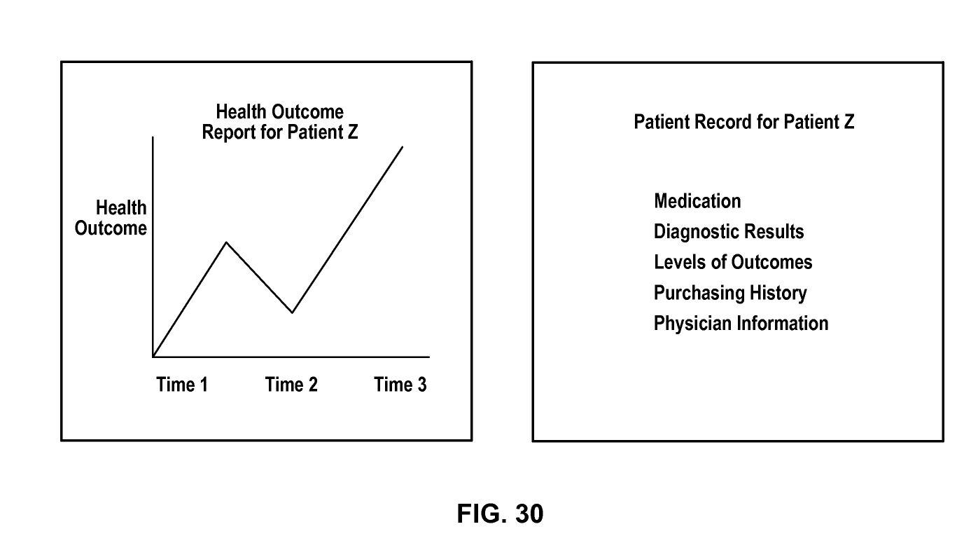

FIG. 30 is a diagram showing sample reports for the patient including a health outcome report and patient record report.

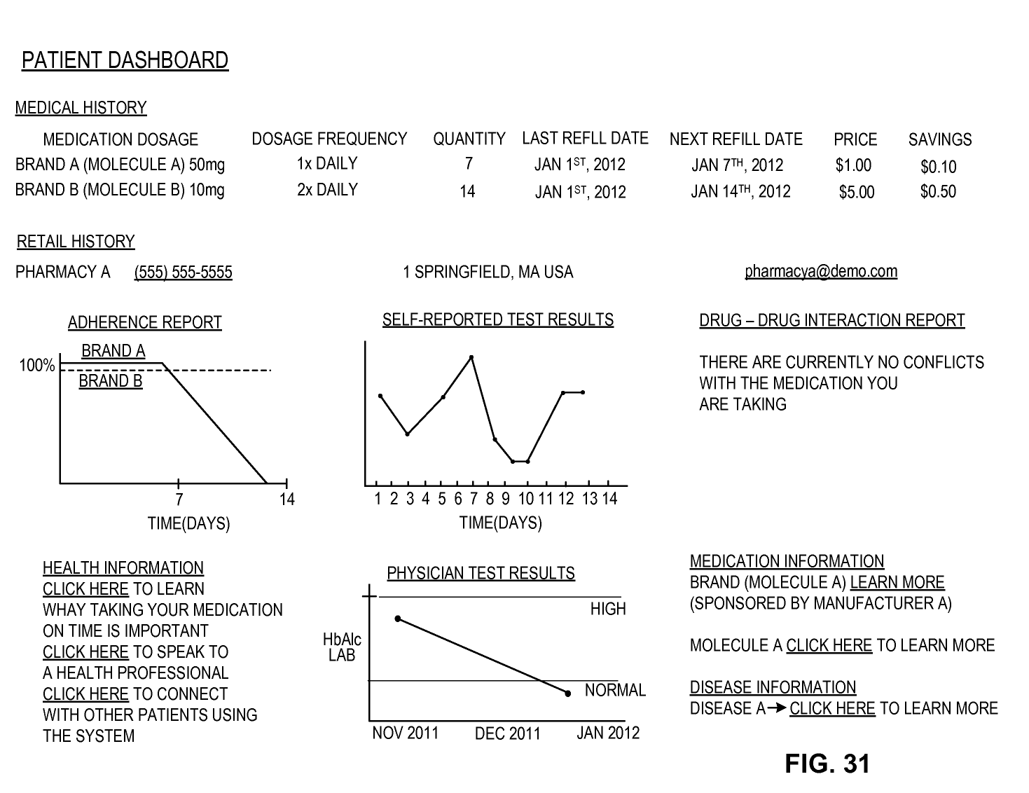

FIG. 31 is a diagram showing a possible patient dashboard.

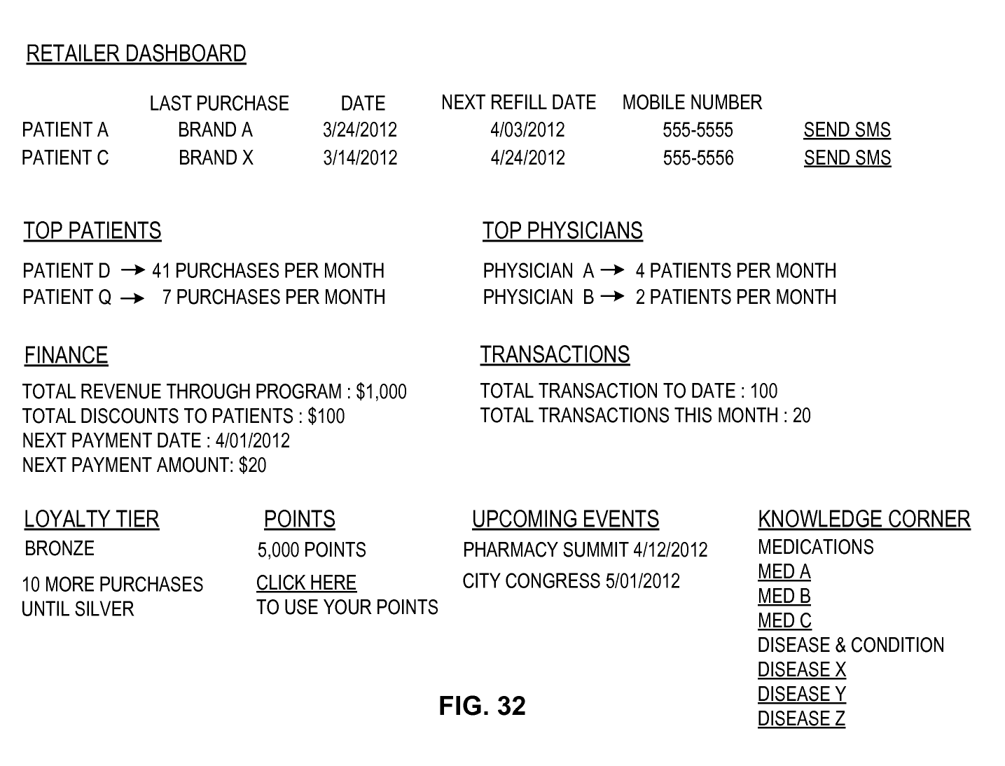

FIG. 32 is a diagram showing a possible retailer dashboard.

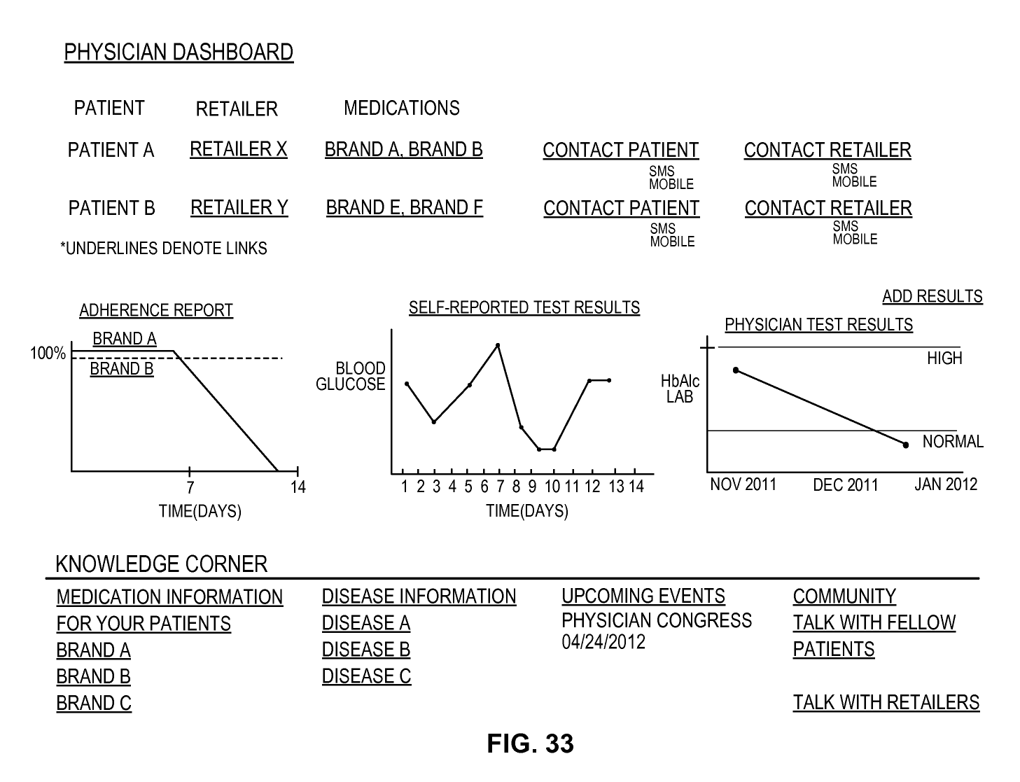

FIG. 33 is a diagram showing a possible physician dashboard.

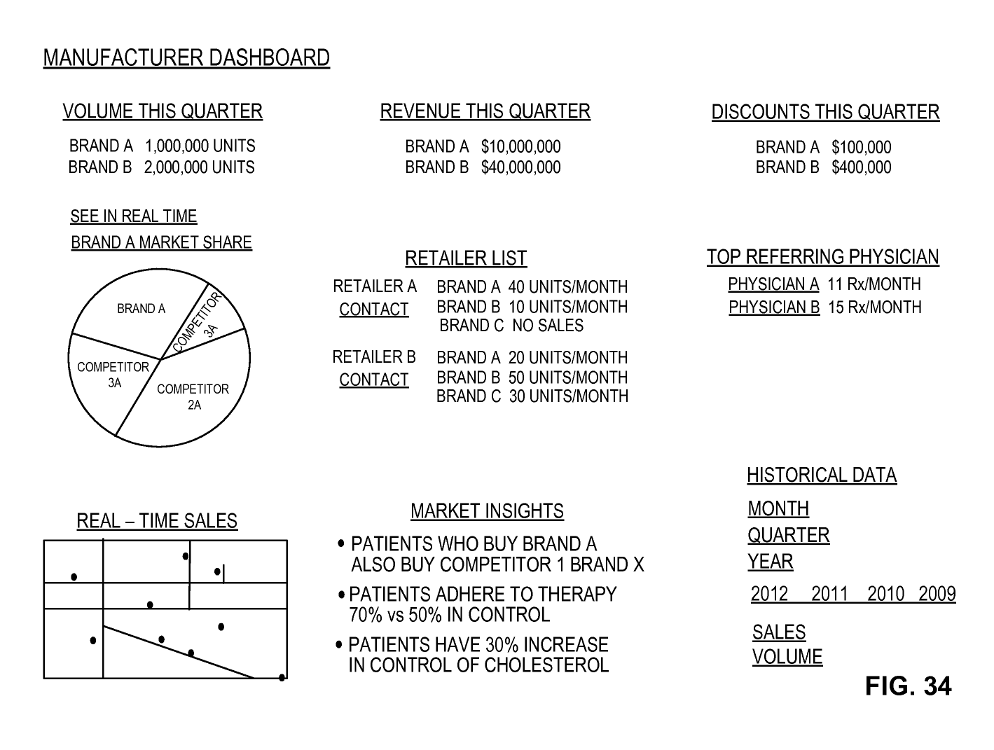

FIG. 34 is a diagram showing a possible manufacturer dashboard.

In some examples of an approach to promoting pharmaceutical products across multiple health care stakeholders that we describe here, a unique identifier is mapped to attributes of a specific promotional campaign that, for example, involves a selected product or selected stakeholders or both. In some implementations, the unique identifier is made known to patients, for example, by physicians advising their patients of the unique identifier or by retailers of the selected pharmaceutical product in connection with dispensing the product to patients, or both.

Each patient can then communicate the identifier, for example, by mobile wireless communication devices, to destinations, such as a central pharmaceutical product promotion management system (which we sometimes call a promotion management system), that make use of the identifier. At the destinations, the communicated information can be recorded, interpreted, or analyzed or any combination of them, for example, by the promotion management system. The identifier can be used in connection with a wide variety of activities related to or in support of the product, the campaign, or the stakeholders, for example.

The promotion system, among other things, can carry out actionable attributes of the campaign. In some examples, the actionable attributes include, but are not limited, to customized communications, timed refill reminders, retailer rebates, or offering of patient discounts sent to relevant stakeholders. The goal of the actionable attributes is to aid pharmaceutical product awareness, affordability, or use, or combinations of those, among others. We use the phrase actionable attributes very broadly to include, for example, any action, step, or process that is associated in any way with the produce, campaign, or stakeholders.

Active responses and passive data received from stakeholders in connection with the product or campaigns or both can be collected by the promotion system. The collected information, including information about the stakeholders and pharmaceutical product campaign information is then updated. Data, analytics, or reports based on the collected information, or combinations of two or more of them, are then produced. A wide variety of data and responses can be collected in a broad range of modes and used for an extensive array of purposes.

Among other things, at least some of the techniques that we describe below assist multiple health care stakeholders in improving, for example, the awareness, affordability, and use of pharmaceutical products by means of unique identifiers and a variety of communication devices. This is depicted in FIG. 1.

We use the term stakeholder in a broad sense to include, for example, any party that stands to be affected positively or negatively by programs that promote pharmaceutical products, for example, manufacturers, distributers, pharmacies, physicians, health care institutions, and patients.

These techniques enhance communication and data flow among the pharmaceutical manufacturer 2, the pharmacist 4, the physician 6, and the patient 8. Using the connected system that we describe here, product awareness can be improved, for example, by informing physicians, retailers, and patients about the safety and efficacy of a particular product, increasing affordability such as through point of purchase discounting, and improving the usage of these products through such programs as targeted medication adherence and education programs for individual stakeholders. A wide variety of other advantages and benefits can be derived from what we describe here.

The techniques that we describe here provide a product-centric and campaign-centric approach to product promotion and are usable on a wide variety of existing platforms without special work to ensure interoperability.

The techniques that we describe here allow for products to be tracked from the point of product recommendation by the physician, to the dispensing of the product by the pharmaceutical retailer, to the purchase of and use of the product by the patient. Customized communications and financial discounts for products can be based on product interactions to be sent to and received by the multiple involved stakeholders. Simple and complex analyses can be done of the tracking data and of the performance of the campaigns and used for a wide variety of purposes.

Here, we describe, among other things, a simple, inexpensive method for promoting pharmaceutical products across multiple health care stakeholders using wireless communication devices. Attributes of these techniques include, but are not limited to, product messaging, financial discounts or rebates and refill reminder prompts associated with the campaign ID.

Information and attributes regarding the pharmaceutical retailers are mapped to the retailer ID. Information and attributes regarding physicians are mapped to the physician ID.

Combinations of a campaign ID and a retailer ID or a campaign ID and a physician ID or any other combination of these and other IDs can be used to form the total ID for the purposes of this invention.

Total IDs can be made known to the patient by the physician and/or the retailer. The patient then can communicate the total ID through a wireless communication device.

This ID information communicated information from the user's wireless device can be recorded, interpreted, and analyzed by the system. The system carries out the actionable attributes of the campaign which include but are not limited to product messaging, financial discounts and/or rebates and refill reminder prompts to the relevant stakeholder or stakeholders to aid product awareness, affordability and use. The system may also be used to field ad hoc communications or payment transfers to any of the health care stakeholders involved.

Among others, a key objective of the system is to promote better multi-stakeholder pharmaceutical product engagement and improve product awareness, affordability and use for key stakeholders. An objective of the system is to integrate key stakeholders involved in patient care through a linked system relying on mobile phones 10 and computer systems 12. The key stakeholders include pharmaceutical manufacturers, physicians, retail pharmacists, and patients, and could include others. In any given action of the system, the system may execute a campaign or ad hoc communication to any single stakeholder, multiple stakeholders, or any combination of them.

As shown in FIG. 2, pharmaceutical manufacturers or other key stakeholders 20 involved in pharmaceutical product distribution, sales, and/or marketing provide information (campaign details 22) regarding a product 24 they wish to promote. Such products may include, for example, those which require a prescription 26 for dispensing or those that can be received without a prescription. In some implementations, information regarding such products may include all or any combination of two or more of the following attributes, among others:

Manufacturer or key stakeholder 28—The identity of the organization or other entity sponsoring the promotional campaign, for example, a product manufacturer, a distributor, or another key stakeholder, or a combination of them, whose objective is, for example, to promote pharmaceutical products for financial gain. The information associated with this attribute may include, for example, the company name, project manager name, location and/or contact information. For example, the name of the pharmaceutical company sponsoring the campaign as well as their geographic location may be associated with this attribute.

Brand Name 30—In the case of a pharmaceutical, the identity of the molecule as noted by its brand name within the geography where the campaign is being deployed. Molecule Name 32—The identity of the molecule under scientific naming standards. Dosage 34—The dosage of the brand that is being promoted by the campaign. For example a pharmaceutical product may be noted as having a dosage of 10 mg/pill. Dosage frequency 36—The suggested number of times a pharmaceutical product is supposed to be taken over a given time period. For example, 1 pill twice daily. Amount (units/pack) 38—The number of pills, tablets, capsules, volume of liquid or other dosage form included in each pack or unit sold of the promoted brand. Retail Price 40—This will include the price of the drug sold in the retail channel. For example, Brand A may be sold by the retailer for $1.00; patient A would purchase Brand A from the retailer for $1.00. In case more than one price is listed for a given drug, the different prices will be noted and classified according to their method of categorization. For example, drugs sold via a chain of retail pharmacies may be at a lower cost than those sold through independent pharmacies. Such differences would be noted and accounted for in the system through categorization which would in turn be mapped to this attribute.

Rebate Amount 42—This will include a rebate amount of the retail price of the drug to be provided to the pharmacist, pharmacists, pharmacy, or pharmacy chain (all considered retailers in our discussion) whether noted as an absolute dollar amount or a percentage of the retail price. For example, in a simple form, if the retail price of the drug to the patient were $1.00, the rebate amount to the retailer for selling that product may be $0.10 or 10%. The rebate amount may also be variable and/or retailer-specific and depend on such factors as length of time a retailer has been involved in a campaign or series of campaigns, may be a fixed value that is provided on a per transaction basis or at a set time period, may be based on a volume of transactions, or may be based on any other criteria which modify a pharmacist margin. For example, the rebate amount may be based on a per transaction basis, on a series of related transactions, or on a series of non-related transactions. The rebate amount may therefore be modified dynamically depending on a variety of criteria that are variable in nature and whose characteristics are gleaned from analyzing trends from a collection of data collected over time.

Additional Product Details 44—This field may include information such as the number of competitors, additional product attributes, therapeutic class, disease treated, indications, historical data, safety and efficacy information, batch and lot numbers and other such information related to the product.

Discount Amount 46—This will include the amount of money that is to be deducted from the retail price for the benefit of the consumer, if applicable. The discount amount may be an absolute dollar amount or a percentage of the retail price. For example, if the retail price of a product is $1.00, the discount amount may be $0.25, allowing the customer to pay $0.75. The $0.25 would be provided to the pharmacist through the system to cover the discount. The discount amount may also be variable and/or patient-specific and depend on such factors as length of time a patient has been involved in a campaign or series of campaigns, may be a fixed value that is provided on a per transaction basis or at a set time period, may be based on a volume of transactions, or may be based on any other criteria that modifies the discount the patient receives. For example, the amount may be based on a per transaction basis, on a series of related transactions or on a series of non-related transactions. The discount amount may therefore be modified depending on a variety of criteria that are variable in nature and whose characteristics are gleaned from analyzing trends from a collection of data collected over time.

Total Discount 48—The total discount represents the sum of the discount made available to the consumer and rebate to be made available to the retailer. This amount may be calculated on a per transaction basis, by a series of transactions, over a fixed or variable time period, or any other criteria as defined by the parameters associated to the discount amount and/or rebate amount. It is the amount or forms part of the total amount that the system will ultimately transfer to the retailer.

Refill Date (from initial purchase) 50—This is used to identify when the consumer should be prompted to refill the medication (we sometimes use the term medication interchangeably with pharmaceutical product). For example, if initially the patient purchased a pharmaceutical product with 10 pills included in each pack (the Amount) with a dosage frequency of 1 pill/day, the system will remind the patient to purchase that drug before, on, or after the 10th day. The system may also send daily reminders or intermittent reminders depending on the objectives of the particular promotional campaign.

Refill Discount 52—This is used to determine the discount if the patient refills. This may be fixed or variable for the product, the retailer, or the patient. The refill discount may depend on a variety of criteria that are variable and whose characteristics are gleaned from understanding trends from a collection of data from consumer interactions and other factors including but not limited to performance with a single campaign or multiple campaigns over time. For example, a patient who refills on time all the time may receive a greater discount that a patient who refills less frequently.

Refill Rebate 54—This is used to determine the rebate amount to provide to the retailer if a refill is made. This may be fixed or variable for the product, the retailer, or the patient. It may depend on a variety of criteria that are variable in nature and whose characteristics are gleaned from understanding trends from a collection of data from patient and retailer interactions and other factors including but not limited to performance with a single campaign or multiple campaigns over time.

Refill Total Discount 56—The total discount represents the sum of the refill discount to be made available to the consumer and the refill rebate to be made available to the retailer. This amount may be calculated on a per transaction basis, by a series of transactions, over a fixed or variable time period or any other such criteria as defined by the parameters associated to the discount amount and/or rebate amount. It is the amount or forms part of the total amount that the system will ultimately transfer to the retailer.

Geography—Identifies the geography of the campaign. Campaigns may be limited to a particular geography. Campaigns may differ based on the geography they are fielded in. For example, two different campaigns for the same product may exist if one is being run in a geography where pharmaceutical manufacturer market share is high and a different campaign with different attributes may be run in a geography where pharmaceutical market share is low.

Campaign Messaging 58—This includes any information that needs to be communicated (or would be desirable or appropriate to communicate) to the relevant stakeholders who are enrolled in or involved in some way with a campaign. For example, a patient enrolled in a campaign may receive a communication (we sometimes use the term communication interchangeably with message) that Brand A also helps improve Condition X or that Pharmacy A is located near the patient. For example, a retailer may receive a message stating that the Total Discount has been transferred to their bank account. For example, a physician may receive a message that the patient filled the prescription of Brand A at Pharmacy A. These messages may be fixed or variable depending on the data collected and analyzed by the system. The communications may differ based on the stakeholder group or specific individual within such group. Furthermore, the sending of these messages by the system may be timed to other events or may be sent independently of such events.

Campaign Start Date and End Date 60—Dates entered here would limit the duration of the campaign. For example, if a campaign were to be run for a single month, dates to this effect could be entered here and once the month was over, the campaign would be terminated, modified, or transferred to another campaign depending on the customizations associated to this attribute.

Once this information is collected it is stored in the system 62. The system assigns a unique identifier (a campaign ID 64) to each campaign. Multiple campaign IDs can be combined to form a single parent campaign ID. Additionally, alphabetical, numerical or alphanumeric characters that represent the attributes may be used. For example, an alphanumeric string may be assigned to the campaign sponsor. The campaign ID can be a number, alphabetic, or alphanumeric identifier. The identifier can be generated randomly, non-randomly, or be generated by hashing one of several attributes. In some embodiments, the campaign ID or the attributes linked to the campaign ID may also be mapped to a QR or Quick Response code, a type of two dimensional code that is easily readable by a variety of devices including mobile devices. In summary, the Campaign ID is used to represent the attributes of a product in a simple form. Therefore, if a stakeholder enrolls in a campaign then the system knows how to treat and classify that stakeholder in terms of communications and/or monetary transfers.

As shown in FIG. 3, in some implementations, a retailer 66 refers to a single pharmacist, several pharmacists, a group of pharmacists, a pharmacy, a chain of pharmacies, or any combination of two or more of them or other retailers of pharmaceuticals. We use the term retailers broadly to include any stakeholder who sells or dispenses pharmaceutical products whether with a prescription or without a prescription to patients or consumers.

Retailers are enrolled in the system using in-person signup, online signup, signup in written form or signup via mobile or other mode of communication. Several attributes associated with the retailers are collected as retailer details 68. Information regarding the retailers may include all or any combination of two or more of the following elements and others:

Company Name 70—This refers to the name of the company that owns and/or operates the retail operation.

Retailer Name 72—This refers to the name of the retail operation.

Mobile Phone Number (Primary Registrant) 74—This is the primary mobile phone number for the retailer account. For example, this may be the mobile phone number that belongs to the owner of a location. In the case that a primary registrant uses more than one mobile phone number, the additional phone numbers will be associated to the primary mobile phone number.

Mobile Phone Numbers (Secondary Registrants) 76—This refers to the secondary mobile phone numbers which may belong to employees, associates or other stakeholders involved in the operations of that retail location. For example, while the primary registrant may be the retail shop owner, each of the 5 employees in the shop may have their mobile phone numbers registered as well. If applicable, this will determine the level of communication and financial incentives they receive from the system regarding the transactions that are processed. For example, a senior employee may receive 20% of the total discount, whereas a junior employee may receive 10% of the total discount. In some instances, secondary registrants may be linked to primary registrants for the purposes of simplifying transactions and communications. In the case that a secondary registrant uses more than one mobile phone number, the additional phone numbers will be associated to the primary mobile phone number for the secondary registrant

Address 78—This is the address of the retail location. In the case of multiple retail locations, this entry would include multiple addresses corresponding to each location. The address may include but is not limited to information such as unit number, street address, city, state/province, country, zip code or other identifiers.

Pharmacist or Other Stakeholder Names 80—This entry includes the full name of the primary registrant and secondary registrants and are each linked to a corresponding mobile phone number or numbers if applicable.

Volume 82—This entry may include the volume of promoted brand products sold in a given time frame whether historical, current or projected.

Additional Information 84—This may include but is not limited to sales information, location information, tax number, license/registration number or qualitative information on the pharmacist or pharmacists. It may also include other contact information including but not limited to an email address or a phone number.

Bank Details 86—Information associated with this element may include but is not limited to banking information to transfer the total discount to the retailer. For example, this may include information to process an electronic deposit, information on a peer to peer money transfer protocol, address information to send deposit checks, or information to transfer payments directly to mobile phones. It would therefore include the necessary account details and the method of funds transfer enabling the system to transfer money as needed. Examples of such protocols are known.

Information associated with this attribute would need to be sufficient to enable the transfer of monies whether through electronic or non-electronic means to the retailer.

Sales Representative or Sales Representatives Information 88—This entry would include the names, departments, contact information, address information and other additional details of any of the sales representatives or account managers who are responsible for that retailer. The sales representative may work for the pharmaceutical manufacturer who has sponsored the campaign or for a contract sales organization contracted by the pharmaceutical manufacturer to promote the product or for any other organization that benefits financially from promoting a product. Furthermore, such an entry may include historical data regarding the sales representative's historical sales, their goals and how they are performing against those goals. For example, the system would note that Sales Representative A is responsible for educating Retailer A about Brand A.

Alternately, this information may be stored separately in a database with its own unique identifier (a sales representative ID) and exist independently or be associated with one or more physician IDs, retailer IDs, or campaign IDs or any combination of them. In the case of a separate sales representative ID, some or all of the earlier mentioned attributes could be associated with the sales representative ID. Such categorization would also enable communication to and from sales representatives through the communication gateway and may involve financial incentives such as bonus payments to be delivered through the banking gateway. In this sense, the sales representatives can, in some implementations, be considered another class of stakeholder.

For example, if information regarding sales representative A is located in the database, the pharmaceutical manufacturer may want to communicate with the sales representative that he or she has accomplished sales targets for the month. The manufacturer could send an ad hoc or system automated message to the sales representative informing him that he achieved his target and that a $1.00 sales bonus will be added to his account. The communication gateway and the banking gateway provided by the system would enable such transactions.

The accumulated retailer details are stored in the system 90 and the system creates a retailer ID 92 which can be a number, alphabetic or alphanumeric identifier. The identifier can be generated randomly, non-randomly or be generated by hashing one of several attributes. In some embodiments, the retailer ID or the attributes linked to the retailer ID may also be mapped to a QR or Quick Response code, a type of two dimensional code that is easily readable by a variety of devices including mobile devices. Additionally, alphabetical, numerical or alphanumeric characters that represent the attributes may be used. In summary, the Retailer ID is used to associate a retailer to attributes that are specific to such stakeholder.

Referring to FIG. 4, physician 94 refers to a single physician, several physicians, a group of physicians, a clinic, a chain of clinics, a hospital, a geographic region containing several physicians or any combination thereof. More broadly, when we use the term physician we include, for example, any stakeholder who can prescribe or recommend pharmaceutical products, whether or not a prescription is required, to patients or consumers.

Physicians are enrolled in the system using in-person signup, online signup, signup in writing or signup using mobile or other mode of communication. Several attributes associated to the physicians are collected. Information regarding the physicians may include, for example, all or any combination of two or more of the following elements, collectively known as physician attributes 96, and others:

Company Name 98—This refers to the name of the company that owns or operates the physician's practice or operations. For example, if the physician's clinic is owned by a company (for tax or other reasons), it would be listed here.

Office Name 100—This refers to the name of the physician's office if applicable. For example, if the physician practices in a hospital, the name of the hospital would be listed here.

Mobile Phone Number (Primary Registrant) 102—This is the primary mobile phone number for the account. For example, this may be the mobile phone number that belongs to the physician. In the case that a primary registrant uses more than one mobile phone number, the additional phone numbers will be associated to the primary mobile phone number.

Mobile Phone Numbers (Secondary Registrants) 104—This refers to the secondary mobile phone numbers which may belong to employees, associates or other stakeholders involved in that physician's practice or operation. For example, while the primary registrant may be the lead physician, the nurses may be entered as secondary registrants. If applicable, this will determine the level of communication they receive from the system regarding the pharmaceutical product or the stakeholders involved. In some instances, secondary registrants may be linked to primary registrants for the purposes of simplifying communications. In the case that a secondary registrant uses more than one mobile phone number, the additional phone numbers will be associated to the primary mobile phone number of the secondary registrant.

Address 106—This is the address of the physician's location. In the case of multiple locations, this entry would include multiple addresses corresponding to each location. The address may include but is not limited to information such as unit number, street address, city, state/province, country, zip code or other identifiers.

Physician or Other Stakeholders Names 108—This entry includes the full name of the primary registrant and secondary registrants which are each linked to a corresponding mobile phone number or numbers if applicable.

Sales Representative or Sales Representatives Information 110—This entry would include any of the names, departments, contact information, address information and other additional details of any of the sales representatives or account managers who are responsible for or assigned to or associated with promotion of the produce to that physician, practice, clinic, hospital and/or regional account. The sales representative may work for the pharmaceutical manufacturer who has sponsored the campaign or for a contract sales organization contracted by the pharmaceutical manufacturer to promote the product or for any other organization that benefits financially from promoting a product. Furthermore, such an entry may include historical data regarding the sales representative's historical sales, their goals and how they are performing against those goals. For example, the system would note that Sales Representative A is responsible for educating Physician A about Brand A.

Alternately, this information may be housed separately in a database with its own unique identifier and exist independently or be associated with one or more physician IDs, retailer IDs, and/or campaign IDs. In the case of such a separate sales representative ID, the aforementioned attributes would be associated to the sales representative ID. Such categorization would also enable communication to and from sales representatives through the communication gateway and may involve financial incentives such as bonus payments to be delivered through the banking gateway. In this sense, such sales representatives could be considered a separate class of stakeholder.

Additional Information 112—Information in this category may include but is not limited to location information, additional contact information such as an office number, prescribing habits, or other qualitative information on the physician or other associated stakeholders. It may also include other contact information including but not limited to an email address or a phone number.

The accumulated physician attributes are stored in the system 114. The system then generates a physician ID 116 which can be a number, alphabetic or alphanumeric identifier. The identifier can be generated randomly, non-randomly or be generated by hashing one of several attributes. In some embodiments, the physician ID or the attributes linked to the physician ID may also be mapped to a QR or Quick Response code, a type of two dimensional code that is easily readable by a variety of devices including mobile devices. Additionally, alphabetical, numerical or alphanumeric characters that represent the attributes may be used. In summary, the Physician ID is used to associate a physician with attributes that are specific to such stakeholder.

Referring to FIG. 5, the steps have shown the elements involved in the creation and use of a campaign ID 120, a retailer ID 118 and a physician ID 122. The campaign ID 120 is a central unifying identifier for a product campaign and the attributes associated with it.

In some implementations, the system combines a campaign ID with a retailer ID to produce a total ID 124. The creation of the total ID may be random, non-random or a combination of the two. The total ID is then made known to the retailer either in person, verbally, in written form, in electronic form, through a mobile phone or through any other mode of communication or through multiple such methods.

When a patient 126 requests a product from the retailer 128 for which such a total ID exists, the retailer will provide the patient with the total ID. The total ID may be provided to the patient in person either verbally, in written form, in electronic form or in any combination of two or more of them. In some examples, the campaign ID may be provided to the patient and he or she may be provided a retailer ID separately. By combining these two elements a total ID will be formed. This represents another method of creating a total ID.

In some cases, when a patient is advised to take a pharmaceutical product whether through prescription or through simple recommendation if no prescription is required and a total ID exists for that product, the physician 130 will provide the total ID to the patient. The Total ID may be provided to the patient verbally, in written form and/or in electronic form or any combination of them. In the case of the physician, the total ID may or may not include the physician ID and the campaign ID depending on the amount of information linked to the physician ID. In another form, the campaign ID may be provided to the patient and he or she may be provided a physician ID separately. By combining these two elements a total ID can be formed. This represents another method of creating a total ID.

Total IDs or parts of them may also be printed directly onto or labeled onto the packaging of the pharmaceutical product. For example, a package of Brand A destined for retailers located in Geography A may be labeled with a specific total ID which may or may not include the retailer ID. This way customization of the campaigns can take place and the communication method of total IDs to retailers and then to patients can be more direct.

Total IDs may be specific to certain groups. For example, a specific total ID may be created and delivered only to a certain geography or to a certain physician type or both. In this way, the campaigns can be customized. Groupings associated with total IDs include but are not limited to:

Retailer Group—Campaigns may be fielded to all retailers in a given geography or different campaigns may be fielded to different categories of retailers within a geography as defined by a collection of data on such retailers as collected and analyzed by the system.

Physician Group—Campaigns may be fielded to all physicians in a given geography or different campaigns may be fielded to different categories of physicians in the geography as defined by a collection of data on such physicians as collected and analyzed by the system.

Patient Group—Campaigns may be fielded to all patients in a given geography or different campaigns may be fielded to different categories of patients in a given geography as defined by a collection of data on such patients as collected and analyzed by the system.

Referring to FIG. 6, in some implementations, the patient 128 uses his or her mobile phone 130 to send in the total ID 132 to a communication receiver using, for example, a short messaging service (SMS) also known as a text message or any other form of communication using one's mobile phone. For example, this could involve sending a string of alphanumeric characters A123B456C to a phone number long code or short code such as 212-555-1234 or 1234. Upon receipt of the total ID from the communication receiver 146 by the application 148, the mobile phone number 134 of the patient is logged along with the date 136, time 138, and time zone of the communication 140, and if discernable, the location of the area code 142 as accomplished by reverse lookup or other means. Additional details 144 regarding the mobile phone number or mobile phone used may be gathered at this time or later. Together with the total ID, this information forms an entry in the patient database 150.

Each time a total ID is sent to the system it is associated with that patient entry within the database enabling multiple products and/or refills of the same product to be associated to that patient. In the case where the patient has more than one mobile phone number, multiple mobile phone numbers can be linked to the same patient account. The system has the ability to prompt the user to register their phone number if not already registered in the system, or if the user is registered in the system with a different mobile phone number, it will ask to link it to other registered numbers. The system also has the ability to assign the patient a user identification—an alphabetic, numeric or alphanumeric unique identifier. This identifier may help associate a patient with his account if the system is unable to link the mobile phone numbers of the users. In communicating with such a patient holding multiple mobile phone numbers a single or multiple phone numbers may be used to communicate with said patient and responses may be received from a single or multiple phone numbers associated with said patient. The patient database contains all of these kinds of information associated with the patient, and can include a wide variety of other information.

In some implementations, the retailer or physician may use his or her mobile phone to text the total ID to the system on behalf of the patient. If this occurs, the retailer or physician will text a phone number long code or short code with the Total ID and the patient's mobile phone number. The patient's mobile phone number may be located before or after the total ID. In some cases, the patient's mobile phone number may be spliced in the total ID. Upon receipt of the total ID and a patient's mobile phone number, the system will recognize that a retailer or physician is registering a patient on his behalf. The system may also check the incoming mobile phone number (physician or retailer) with the information already stored and associated with the stakeholder profiles. The system may also check if the patient's mobile phone number is already registered in the system and link the accounts.

Once the total ID is received and the initial data is collected, the system can easily track contact with the key stakeholders. Receipt of a total ID causes the application to map the received identifier to the campaign, retailer, and or physician for which it was generated and link it to the patient's account. This mapping can be done via one or more of multiple means including but not limited to codebooks which store each unique identifier with its associated attributes. Other means for mapping may include algorithms that could deduce this information from the total IDs themselves as attributes regarding campaigns, retailers, and/or physicians would have been encoded in the unique identifiers at the point of identifier generation. There are many algorithms for achieving this, several of which are noted in the literature such as hash functions and fingerprinting algorithms. Therefore, by mapping the received identifiers with linked attributes, the system is able to link in near real time product promotional campaigns to the retailers, physicians and patients who are involved in such campaigns and therefore enable immediate action on the basis of their interactions.

Referring to FIG. 7, in some implementations, the system includes three primary functional modules that (along with other modules) can be implemented in software, hardware, or a combination of them on a wide variety of platforms. The three primary modules are a payment gateway 152, a communication gateway 154, an application 156, and a set of databases 158 that store collected information.

In some instances, the databases include but are not limited to a Campaign Database 160, a Patient Database 162, a Retailer Database 164, and a Physician Database 166. The databases may be held separately within the system or may be consolidated into a single database or multiple databases as necessary. Other databases can also be part of the system.

In some examples, the banking gateway enables the transfer of funds to and among stakeholders and the host of the system. The sender and receiver of such funds require bank information to be accessible by the system whether such information is held internally or externally. Transfers of funds between senders and receivers can take place using a variety of mechanisms including but not limited to electronic funds transfers, mobile banking, check, cash, money order, or other mechanism of financial transfer covered by the prior art. For example, a pharmaceutical manufacturer may transfer a rebate to a retailer from its bank account to the retailer's bank account or through an intermediary. Furthermore, the system may post funds to a stakeholder's account, but not make the physical financial transfer unless a future event is executed or a certain time period has elapsed. For example, a retailer who sells a promoted product to a patient and is owed a total discount of $0.30 may be paid such amount instantly or that $0.30 may be posted to their online account but may not be transferred to his or her account until it reaches $10.00. Therefore, the system is able to calculate, store and transfer payments based on criteria defined through system controls and to make the payments conditional. Online and mobile payment systems are known.

In some cases, the communication gateway 154 enables the transfer of messages to and among stakeholders. The communication gateway relies on two points: a sender identification and a receiver identification. Mobile phones are used primarily to accomplish such tasks. In some instances, communications may be done in person, in written form, in electronic form or through any other mode of communication.

Referring to FIG. 8, as noted previously, information about the product campaign, the patient, the retailer, and/or the physician, among other things, can be collected and stored in the system either as a single database, multiple databases, distributed, databased, or any combination of those 168. Once a total ID is received, the system interprets the identifier and maps it back to the attributes of that campaign, the retailer, the physician and/or the patient depending on the information received in a step known as campaign initiation 170. Once received, the system will execute the campaign 172 according to the attributes for that campaign and may also modify certain attributes or treat campaigns in a variety of ways.

For example, once a campaign for Brand A is executed, a consumer may receive a message on his mobile device 174 stating that he received the product for $0.25 instead of $0.60 and that Brand A was shown to be effective in reducing the symptoms of disease X by Y percent, or similar educational information. The pharmacist may receive a notification that the $0.35 discount plus a rebate of $0.10 has been transferred to his bank account. At this time, the system may, depending on predefined criteria, transfer funds to cover the total discount of $0.45 to the pharmacist's bank account. The physician may receive a notification that Patient A filled his prescription at Retailer X.

Any responses to closed or open ended questions or queries that are sent to any of the campaign messaging protocols are received by a communication gateway 176 and the system updates the data 178 in the databases.

Upon campaign execution, the relevant financial amounts can be transferred through the payment gateway 180 to the stakeholder's bank account or similar method of funds receipt 182. The system acts to monitor the stakeholders throughout their enrollment in the campaign. As such, the system may note that a patient has not refilled his prescription at a retailer in a given time period. The system would note this, for example, because no new total ID for that product was received within the duration of the Refill Date as defined in the Campaign attributes from the time and date of the receipt of the original total ID. In such a case, the system would prompt the user to refill his product, and such a reminder may include simple communications, or financial and non-financial incentives.

The system or in certain cases, operators of the system (we sometimes refer to the operators as the host or hosts of the system), monitor incoming and outgoing data and are able to develop rules which serve to enhance the performance of campaigns through multi-stakeholder approaches. The system or operators of the system are able to use all the databases, single databases or any combination of them to optimize such campaigns.

For example, the system may tie together multiple data sets and create a communication targeted to a patient that may state “Thank you for purchasing Brand A from Retailer A. Physician A encourages you to take your dose 3× daily”. In some examples, this information would be gathered by following the patient from the time when he or she is recommended the medication by the physician and given a total ID to the time when the patient sends in another total ID when the prescription is filled at the retailer. The system therefore has all the necessary attributes to provide a customized communication to the patient. Furthermore, the system has the ability to track the patient going forward and initiate campaigns even if a total ID is not received as long as the stakeholder is already in the system.

Referring to FIG. 9, in some implementations, the system also allows for ad hoc messaging and communications and/or payments 184 with stakeholders to occur. Furthermore, information about stakeholders can be sorted by a variety of variables as stored in the databases 186 that were collected initially and are continuously updated. Stakeholders can then field a communication and/or payment 188 to an end user, for example, to the end user's mobile device 190 through the communication gateway 192 in the case of a communication or to their account 196 through the payment gateway 194 in the case of a payment transfer.

For example, a pharmaceutical manufacturer may wish to notify retailers and physicians that a new drug has been launched in Region X (a geography). This message would then be fielded to all the retailers and physicians in Region X. In another example, a manufacturer may wish to conduct market research and retailers may be asked if they stock a brand. The retailer would respond using his or her mobile phone and the responses would then be used to update the databases. In another example, all retailers who carry a product may be notified that the product has been recalled. In another example, a payment may be transferred to all retailers on behalf of a pharmaceutical manufacturer for a one-time rebate.

The system would then either simply log the responses or categorize individuals or groups according to their responses 198 and enroll them in new campaigns or provide further messaging content.

Ad hoc messaging may be delivered in person, in written form, in electronic form, on the phone, or through any other mode of communication. Ad hoc payments processed by the payment gateway can take place via a variety of mechanisms including but not limited to electronic funds transfers, mobile banking, check, cash, money order, or other mechanism of financial transfer.

Referring to FIG. 10, in some instances, the system collects a vast amount of data and constantly updates the data based on passive and active responses from multiple stakeholders. As such, the system is able to request and analyze such data 200 from the databases 202 and display it in the form of metrics, reports or other visualization tools 204. For example, the system may know that Physician A recommended Patient A to take Brand X and Patient A received Brand X from Pharmacy A located in Region 1 at Time X. In this case, the system could follow a patient's history across multiple stakeholders and in the case where regional information were available, could be plotted on a map.

A series of distinct (e.g., independent) transactions or sequences, or behavioral patterns, for one or more patients, such as those noted in the example, may be collected and analyzed according to a series of variables. Furthermore, the system may calculate and display data on an aggregate basis. For example, the system could calculate based on the information collected that 40% of patients in Region 1 refill their medication on time, or the average discount for Brand X is $0.20, or there are 10,000 patients registered in a campaign.

The data and analytics produced may be viewed using any device capable of displaying such information or may be produced and disseminated to the relevant stakeholders in written form. Additionally, stakeholders may use their mobile devices to access information on the system. For example, a physician may text or SMS a registered patient's mobile phone number to the system and receive a report on their product use history including which medications they are using and their adherence and persistence to therapy rates. In another example, a pharmacist may want to understand how many of his patients are refilling their medications on time which could be provided by the system. In another example, a pharmacist could check their account balance or transaction history by communicating to the system using a mobile device. Furthermore, information residing in the system may be able to be accessed via computer in which case more detailed information may be available.

There are many possible reports that can be generated from the data some of which include but are not limited to:

As depicted in FIG. 11, the system collects a variety of information and has the ability to display this data in various forms. Data can be filtered by a variety of attributes that are collected.

In some implementations, various graphs and charts 206 could be formed to visualize this information. Attributes 208 stored in the system can be used to filter the type of information displayed by the system. Filters may include a single attribute or multiple attributes. Filters may also exclude certain attributes. Attributes collected that can be used as filters (either individually or in combinations of two or more of them) include but are not limited to:

Manufacturer—210, Brand—212, Molecule—214, Dosage—216, Dosage Frequency—218, Amount—220, Retail Price—222, Rebate Amount—224, Total Discount—226, Refill Date—228, Refill Discount—230, Refill Rebate—232, Refill Total Discount—234, Geography—236, Patient Group—238, Physician Group—240, Retailer Group—242, Campaign Start Date—244, Campaign End Date—246, Company Name—248, Retailer Name—250, Mobile Phone Number—252, Pharmacist—254, Physician—256, Sales Representative—258, Office Name—260, Additional Information Associated to Campaign—262, Retailer—264, Physician—266, Sales Representative—268, Date—270, Time—272, or Time Period—274

In some cases, filters can limit the variables that will be plotted on the graph or other visualization. For example, if a stakeholder wishes to know the sales volume of a single retailer over time, one would select retailer as the filter and chose Product Volume Sold and Time as the y and x variables, respectively. Variables are usually quantitative in nature which ascribe to this method of visualization. Variables include but are not limited to:

Product Sales—276, Product Volume Sold—278, Date—280, Time—282, Retail Price—284, Margin—286, Discount—288, Rebate—290, Total Discount—292, Refill Discount—294, Refill Rebate—296, Total Refill Discount—298, Average Discount—300, Rebate or Total Discount—302, Patient Medication Adherence Rate—304, Patient Medication Persistence Rate—306, Prescriptions Written—308, Product Margin—310

In some instances, variables may be used as filters. For example, one may wish to understand the average discount over time within a highly adherent patient population with an adherence rate greater than 80%.

As depicted in FIG. 12, in some implementations, it is possible to generate detailed patient reports as their drug purchase history is recorded. An adherence report 312 for a single patient or a set of patients could be generated. The system knows when a patient first fills their medication, knows the dosage frequency and the amount and therefore knows the refill date. Therefore, an adherence rate can be calculated. This is one example of a patient-specific report. Similarly, a refill rate 314 could be calculated from the same information and this may be able to indicate what long term persistence to the medication may be.

As depicted in FIG. 13, using the system data, it is possible to generate custom reports for each patient which could display if there were any drug-drug interactions 316. As the system logs drug purchases it is able to create a linked patient record that will then allow for rules-based detection of drug-drug interactions. For example, if a patient takes Drug 1 and it conflicts with Drug 3, the system could push a communication to the patient, the retailer and/or the physician noting the drug-drug interaction and to stop taking the medication immediately. Furthermore, the system could also document the diseases that each patient has and generate a co-morbidity report 318. Because the system knows the drug and therefore the indications of that drug, it is able to create a history for the patient that documents their co-morbidities.

As data is collected in the system in near real-time, it is possible to display this data in an active format. As depicted in FIG. 14, the system could display an active map 320 where retailers 322, physicians, patients 324, sales representatives or other stakeholders registered in the system are represented on the map. As the system knows the location of each of the stakeholders due to stored address information or has proxy measures of obtaining their location such as reverse area code lookup or assuming a patient's approximate location based on the location of the retailer they just purchased from, it is possible to plot locations on a map. It is then possible to visualize exactly when a sale is made and what type of sale is made. For example, one could view that Retailer 1 sold a product to Patient A on Jan. 2, 2010 at 3:43 pm EST.

As the system collects transaction and behavioral data regarding multiple stakeholders, it is possible to compare across stakeholders. For example, one could compare the sales of the same molecule in a certain geography between Manufacturer A and its competitor Manufacturer B. One could also compare the number of prescriptions for a certain branded medication written by Physician A versus Physician B. One could also measure how one Sales Representative performs relative to another Sales Representative as measured by product sales. Many such comparisons are possible. Stakeholders include but are not limited to:

Manufacturer—326, Physician—328, Retailer—330, Patient—332, Sales Representative—334

Variables that can be mapped include but are not limited to:

Product Sales—336, Product Volume Sold—338, Retail Price—340, Margin—342, Discount—344, Rebate—346, Total Discount—348, Refill Discount—350, Refill Rebate—352, Total Refill Discount—354, Average Discount—356, Rebate or Total Discount—358, Patient Medication Adherence Rate—360, Patient Medication Persistence Rate—362, Prescriptions Written—364, Product Margin—366

These variables could be filtered by date and time or any other set of filter types.

We use the term campaign in the broadest sense to refer to, for example, a group or series of promotional elements of any kind or nature. The elements could include, for example, a combination one or more of rebates, discounts and messages that are designed to promote a pharmaceutical product.

We use the term product or (sometimes interchangeably) pharmaceutical product in the broadest sense to refer, for example, to any drug, medication, or other product (or service) used for health or wellness purposes.

We use the term stakeholder in the broadest sense to include, for example, any party that stands to be affected positively or negatively or both by any campaign or other program that promotes products such as pharmaceutical products, for example, manufacturers, distributers, pharmacies, physicians, health care institutions, and patients.

We use the term unique to refer to the nature of the identifier in that it is different from other identifiers. A unique identifier, for example, refers to any unique number, alphabetic, or alphanumeric string of characters or visual representation (such as a quick response code. Two unique identifiers, for example, A42342 and B23498, may or may not refer to the same set of attributes that they are linked to or associated with but the representations of that set of attributes will be different for the two unique identifiers.

We use the term actionable in the broadest sense to refer, for example, to any activity, event, step, or transaction, or any combination of them, including an executable command by the system that performs a certain transactional function. Messages, communications, rebates, and discount transfers are examples of actionable commands.

We use the term ad hoc in the broadest sense, with reference to messages, rebates, and discounts to mean, for example, not pre-programmed to be part of the actionable attributes of the campaign. Ad hoc communications or payment transfers, for example, can be initiated without being pre-programmed into the campaign. For example, a patient may already be enrolled in a campaign for Product A and will be receiving communications that are associated with that campaign, but the system can use an ad hoc action to notify the patient about a new product that may be of interest and was not originally part of the campaign attributes.

We use the term enrolled in its broadest sense to refer to, for example, registration such as stakeholder registration. Once a stakeholder is registered in the system for the first time by receipt of a total ID or other method of signup, the stakeholder is considered to be enrolled into the system, as a record has already been created for the stakeholder.

We use the term geography in its broadest sense to refer to any arrangement or location of places. For example, a city block may be considered a geography, similarly, an entire country may be referred to as a geography.

The concepts, techniques, and devices discussed above can be implemented in a wide variety of ways and on a wide variety of computational, networking, and mobile platforms. Any computing device and any mobile device may be used for interaction of a stakeholder with the system or with other stakeholders, for storing information, and for performing actionable elements.

Information used in the system can be held in any kind of storage device at one or more locations. The storage devices can be associated with computers or mobile devices.

The computing devices can be any form of digital computer, such as laptops, desktops, workstations, personal digital assistants, servers, blade servers, mainframes, and other appropriate computers. The mobile device can be, for example, any kind of personal digital assistants, cellular telephones, smartphones, and other similar devices.

The computing devices may each include a processor, memory, a storage device, a high-speed interface connecting to memory and high-speed expansion ports, and a low speed interface connecting to low speed bus and storage device. The processor can process instructions for execution within the computing device, including instructions stored in the memory or on the storage device to display graphical information for a GUI on an external input/output device.

The computing devices may be implemented as a standard server or a group of such servers.

Each device may communicate wirelessly through a communication interface under various modes or protocols, such as GSM voice calls, SMS, EMS, or MMS messaging, CDMA, TDMA, PDC, WCDMA, CDMA2000, or GPRS, among others. Such communication may occur, for example, through a radio-frequency transceiver. In addition, short-range communication may occur, such as using a Bluetooth, WiFi, or other such transceiver. In addition, a GPS (Global Positioning System) receiver module may provide additional navigation- and location-related wireless data to each device, which may be used as appropriate by applications running on device.

Each device may also communicate audibly using audio codec, which may receive spoken information from a user and convert it to usable digital information. The audio codec may likewise generate audible sound for a user, such as through a speaker, e.g., in a handset of device. Such sound may include sound from voice telephone calls, may include recorded sound (e.g., voice messages, music files, and so forth) and may also include sound generated by applications operating on device.

The mobile device may be implemented in different form, for example, as a cellular telephone, a smartphone, a personal digital assistant, or a tablet computer.

Various implementations can include one or more programs or applications or apps that are executable and/or interpretable. These computer programs (also known as programs, software, software applications or code) include machine instructions for a programmable processor, and can be implemented in a high-level procedural and/or object-oriented programming language, and/or in assembly/machine language. The terms “machine-readable medium” “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback). Input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network).

Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The system may include other features and concepts.

In some implementations, the retailer or the physician or both can serve as a proxy for one or more patients for registering and interacting with the system.

For example, referring to FIG. 16, in some implementations, the Total ID need not and may not be made known or provided to the patient 360 to enable the patient to register him or herself with the campaign. Rather, at the time when the patient and physician or retailer are interacting, the retailer or physician 362 may identify the patient to the system (e.g., assist with patient registration) by using his or her mobile phone 364 to text an identifying number 390 such as the Total ID to the system followed or preceded by the patient's mobile phone number which has been provided by the patient. In some cases, the patient's mobile phone number may be spliced into the Total ID.

In some examples, the retailer or physician 362 uses the mobile phone 364 to send an identifying number 390 that includes at least one of the Total ID, Campaign ID, or Retailer ID to a communication receiver 372 using, for example, a short messaging service (SMS) also known as a text message or any other form of communication of which the mobile phone is capable. Upon receipt of the Total ID from the communication receiver 372 by the application 374, the mobile phone number 366 of the patient is logged in the system 376 and linked in the system to the campaign.

In this method of retailer-assisted registration, a mobile phone number 365 belonging to the retailer 362 (primary or secondary registrants) could be registered with the system by sending a text 391 from the mobile phone 364 to be registered to the application 374, which includes the Retailer ID 393.

In this case, the Retailer ID will not be shared with the patient. It can potentially be used solely by the retailer 362; in this way it the Retailer ID can be used to register additional mobile phone numbers belonging to multiple patients to a retailer account. The Retailer ID may be texted to the system along with a Campaign ID or any other pre-defined commands 379. A similar method could be employed for physicians wishing to register numbers.

In some implementations the physician or retailer 362 can select system options 368 on behalf of the patient 360. These can include linking mobile phone numbers 361 for a patient if a patient has a new mobile phone number that has not previously been recorded in the system. Similar commands such as opting out of messages 363 or opting in to messages 365 or checking account details 367 could also be performed by the retailer or physician for the patient. To accomplish this, the retailer or physician would text a specific code 373, for example, a link, along with the two numbers 375, 377 in such an order that the old and new number could be deciphered by the system due to positioning or through other means of flagging or identification, in order to connect the two numbers.

In some implementations, when a retailer texts the system with the Total ID followed, preceded or otherwise connected with the patient's mobile phone number 366, additional information can also be shared. For example, the retailer could enter patient demographic data 370 such as the patient's gender, age, address, physician's name, physician's location and/or any other demographic information. Such additional information would be received by the system 376 and stored in a single database 377 or multiple databases 379.

Referring to FIG. 17, in some implementations, at the time of an initial purchase, the patient 360 may be assigned a unique user identifier 392 which can be numeric, alphabetic or a combination of them. This unique identifier may be provided to the patient on paper or electronically. In an initial purchase text 393 from the patient, or retailer to the application 374, this unique identifier would be added to the text message along with an identifying number 390 such as the Total ID, and the patient's mobile phone number 366. This unique user identifier would then represent the mobile number 366 of the patient. Therefore, in subsequent purchases, the patient could provide this user ID to the retailer instead of her mobile number and due to the prior linking, the system would know where to send any text messages intended for the patient.

In some examples of an assignment of a unique user identifier, the system could respond to the patient, after the texting of the patient's mobile phone number 366, and could include a generated unique user identifier 392 in the response which would take the form of a text delivered to the patient's mobile phone 380 now associated with the patient's mobile phone number 366.

Referring to FIG. 18, in some cases, a physician 398 may provide a unique user identifier 399 to the patient at a visit. This unique user identifier may or may not be linked to a Physician ID and/or Campaign ID. The physician may associate the unique identifier 399 with the patient's mobile phone number 401 by sending this information to the system.

Again referring to FIG. 18, in some cases the patient 400 may link the unique identifier 399 to her mobile phone number 401 herself by texting her unique user identifier 399 and her mobile phone number 401 to the system 406 using her mobile phone 404. Some methods of associating a mobile phone number to a unique user identifier can involve other computer assisted methods such as through online systems such as a web portal or interactive voice response.

In some instances, the patient 400 herself could text patient demographic data 430 including the patient's gender, age, address, physician's name, physician's location and/or any other demographic information. This could be sent with an identifying number 428 such as a Campaign ID, Physician ID and/or Total ID.

Referring to FIG. 19, in some examples, a patient 420 can generate a unique user identifier 428 prior to a first purchase. In this case, the patient 420 may generate such an identifier using an online system or through interactive voice response or other such computer assisted system 426 by registering her mobile phone 422 number for her program. For example, a patient who has heard about a program may go to a website to register her mobile phone number 422 and will be provided with a unique user identifier 428 by the system 427. Registration can be done at any time if the patient has not already been assigned a user identifier or needs a new user identifier. When the patient visits a registered retailer, she would need to provide her unique identifier which instead of the patient's mobile phone number would be texted along with the Total ID to the system. However, either the unique identifier or the mobile phone number would be sufficient to identify her as the appropriate recipient.

In some implementations, a physician may only text a Campaign ID instead of texting a Physician ID and also text their company name, office name, mobile phone number or numbers, address, physician or other related stakeholder names, sales representative or sales representative information and/or additional information.

Referring to FIG. 20, in some instances, a retailer 430 could use his or her mobile phone, digital camera, or scanner 432 to take a photo or image 434 of the patient's prescription and send it to the system either using mobile networks or using a computer through the internet. Once received by the system 436, these images may be stored, and/or deciphered by text recognition software and/or the information on these images could be manually entered into a single or multiple databases and linked to single or multiple stakeholders by the system 436.

If additional information is provided in any such methods, the system may send an additional payment transfer to the retailer or physician or in the case of a patient, provide an incentive in the form of a purchase discount or mobile airtime or minutes.

Referring to FIG. 21, in some instances, messages to the patient 448 or other stakeholder may be sent from a first stakeholder in behalf of a second stakeholder. For example, a message 440 to a patient 448 that is sent in connection with a prior purchase of Medication X at ABC Retailer may say ‘Taking Medication X twice daily has been proven to reduce cholesterol levels. Sent by ABC Retailer’. While ABC Retailer is not sending the text message itself, the name of the retailer will appear in the text message 444 such that it will seem to the recipient that it is sent by that stakeholder. The name of the retailer, name of any of the associates who work for the retailer or in the retail shop, or the name of any other stakeholder or any other defining characteristics may be included in the message text to assign responsibility for the text message to another party.

In some instances, it may be necessary or useful to check if fraudulent activity exists. Referring to FIG. 22, some methods include having the retailer keep dispensing records 450 such as detailed invoice records including but not limited one or more of the following details: patient name, patient mobile number, treating physician's name, manufacturer of product purchased, brand name, dosage, time and date of purchase or any other such pertinent details. These invoices will be used to reconcile the records generated by the system 452 with paper records to help reduce the risk of fraud.

One method of fraudulent activity is to provide a discount to a patient and keep the reimbursement without having sold the medication or having sold a different medication from a manufacturer who is a not a stakeholder. Other methods of fraud identification and reduction include but are not limited to tracking the number of products sold by a particular retailer versus the average number of products sold by all retailers in a particular geography or other definable group. This will allow for the identification and follow up of particular retailers who are outliers from the average. Once verification is made, payment 456 can be deposited into the stakeholder account 458. Alternatively, verification can take place after the payment is deposited into the stakeholder account.

In some instances, instead or in addition to an invoice, the dispensing record 450 can take the form of a registration card including similar details that may be required to be filled by the patient or by the retailer for the patient and kept by the retailer. In some instances the dispensing record 450 can take the form of certain parts of the packaging of the medication kept by the retailer to prove that the particular drug was sold and that discounts were not claimed fraudulently. In some cases, medication packaging may have particular unique identifiers in which case that information would be kept by the retailer for reconciliation and fraud checking by the program administrator.

Referring to FIG. 26, in some instances, a unique label identifier 530 may be labeled on the product label 535 itself such that the Campaign ID will be openly displayed or linked to another unique identifier which is not provided. This method where several unique labels are linked to a single unique Campaign ID helps to ensure that only a certain number of discounts is authorized. A patient or retailer 540 can send a particular unique label identifier 530 to the system. The system 545 then executes comparison step 548, comparing the sent unique label identifier to those listed in the associated campaign database 546. If the unique label identifier 530 is not valid, the system may send a message 550 to the patient or retailer's mobile device 552. If the result of comparison step 548 is that the unique label identifier is valid, a command 554 will delete the unique label identifier from the list of valid identifiers. The system will also send the appropriate discount or payment to a payment gateway 558, resulting in a payment 560 being transferred to the end user's account 562. For example, if 100 packs of Brand X are authorized for discounts, 100 unique labels would be produced which will be linked to the same Campaign ID or potentially more than one Campaign ID to test efficacy of different Campaigns. This information on these unique labels may not be used again once texted into the System. It is also possible for these unique labels to include the Retailer ID and therefore form the Total ID if the destination of the products is known.

In some instances, instead of financial incentives or discounts for various actions, a payment can take the form of mobile minutes or airtime to be provided to the stakeholder directly to her mobile phone. For example, if Brand A is $1.00 and the discount would be 10%, that patient may still pay $1.00 but receive $0.10 in mobile airtime or credit. Similarly, such systems may be employed for market research incentives or other forms of stakeholder compensation along with traditional financial incentives.

Referring to FIG. 28, a discount can be provided to a patient in response to solicited patient input. For example, the system 610 can send questions 615 through an interactive system such as a mobile device, voice messaging system, or other computer-assisted interactive system 620. The patient 600 can provide answers 605 through the same medium. Once all answers have been given, the system 610 may provide the patient 610 with a unique discount code 630 associated with the patient. This unique discount code 630 can be used by the patient in a future purchase.

Referring again to FIG. 9, in some instances, a text message may be sent after an initial purchase to a patient to verify that a purchase was actually made and that the patient did register in the program and is entitled to the discount and/or other benefit. For example, immediately or sometime after the purchase transaction is made, the system may send a message 188 to the patient asking him to text back a response to confirm that he received the discount and/or received the eligible medication. Such text messages soliciting a reply could be used to ascertain specific details about the transaction including but not limited to the physician name, the quantity purchased, the dosage, the date which could then be checked against the system records, the invoice, the registration card and/or other transaction records.

In some instances, it would be possible for a stakeholder to find out which other stakeholders are participating in the program. Referring to FIG. 10, for example a patient may send a text 200 to the system in a set format requesting the locations of all the participating retailers in his or her area. The system may need or ask for additional location information to provide a more accurate response or may also use the patient's prior purchasing history to figure out their possible location and provide the response in this manner.

As shown in FIG. 23, in some instances, when an identifying ID 482 such as a Campaign ID is texted by the patient, or by the retailer or physician for the patient, it may not result in an immediate discount or action, rather it may be simply noted by the system 484 and tracked. Each time a purchase is made, the system 484 will track this. A discount or other action may take place when a certain purchasing criteria 486 is reached. If that criteria is not met, messages 488 may still be sent to the patient and/or other stakeholders.

This method allows for a loyalty system where the number of purchases is tracked and when a patient reaches a qualifying purchase criteria 491 either receives the purchase free or receives a discount on it. For example, Brand Y may be qualified for a buy 5 get 1 free scheme. In this instance, the patient would not receive any discounts for the first five purchases (whether all at once, one at a time or any purchase combination over time), but would still need to text or in or have texted in along with their mobile phone number a Total ID for each purchase that is made so that on the 6^{th} purchase, he or she receives the medication for free. When this purchase criteria is met, a message may be sent to the payment gateway 492 to transfer funds into the retailer's account who will then pass the benefit of the free product to the patient 494. The method of discount here would be a 100% discount (where the full retail price or portion thereof depending on the agreement with the retailer would be reimbursed to the retailer—in some cases, the retailer margin in this case would be reduced or not paid therefore 100% of the retail price would not be reimbursed—this is built in the belief that the retailer is also gaining) or in the case where the manufacturer provides sample packages, which are packaged and classified differently, a sample package would be given to the patient. Whether provided as a sample package or a regular good with complete or significant reimbursement, a unique label may be used to ensure tracking and limit fraud. This is not mutually exclusive with the previously described operation of the system and both instant discounts and tracked discounts may be used.

Referring to FIG. 27, in some instances when a qualifying purchase (i.e., the 6th in the current example) is made and the approved purchasing criteria 486 is met, the system will send a unique discount ID 570 or similar unique number to the patient 572. The patient then will show the unique discount ID to the retailer or pharmacist and the pharmacist will text the ID along with the patient's mobile number to the system 580 before a discount is applied. Thus the unique ID is a one-time only code specific to the patient's record.

Referring again to FIG. 23, tracking and/or restricting the number of medicines that can be purchased at any given time or over a certain time period can prevent another type of fraud in which the patient buys multiple medications either alone or in collusion with the retailer for the purposes of resale, as the medications may be purchased at a discounted rate, or in order to help generate more income for the retailer through collusion. There may be a limit in purchases per patient where the system restricts the number of claims made by a particular mobile phone number, or phone numbers in the case of account linkages, to a certain number. For example, if Brand X is taken daily and the average duration of a prescription for Brand X is 3 months and Brand X is sold in a one month supply, the system may restrict the number of claims from the same mobile number to three months. Therefore, the patient could only purchase a maximum of 3 packs or a 3 month supply at any one given time.

In some examples, the total duration could also be monitored and purchase restrictions could be made on this basis. For example, if a patient purchasing Brand X buys 1 pack or 1 month's supply the first month and then 2 packs or 2 month's supply two weeks later, then the system will not allow any more purchases until after the end of the third month after the first purchase was made. There can be flexibility in this case where it would be possible to authorize a discount for 4 packs purchased within a 3 month period which would allow for different patient purchasing habits.

In some cases, the expected duration of a supply of medicine would be monitored and restrictions would be placed for refills made during this period. For example, if one pack of Brand X is purchased and it is a one month's supply, no other purchase of the drug made during the first month would qualify for a discount, however, as soon as the first month was completed and the second month begins, the patient could avail themselves of a discount on a purchase of Brand X again, response 491, allowing the purchase and any relevant discounts. It is also possible to provide flexibility around the end refill dates. For example, one pack of Brand X was meant to last one month, it could be made so that another pack could be purchased 5 or 10 days or such a time period before the end of the month and this purchase would still qualify for a discount. Therefore, there are several ways to reduce fraudulent activity.

Furthermore, in some instances, any registered retailer mobile numbers may be restricted so that these numbers will not qualify to receive a discount. This prevents fraud in the case a retailer is using his or her own mobile phone to avail themselves of a discount reimbursement and/or rebate reimbursement while not passing the intended benefit of the program to the patient.

Referring to FIG. 23, in some instances, this method of tracking, which does not involve discounts to be provided on each purchase, could be used to provide a loyalty points system, where purchases would qualify for points, miles or other reward which are able to be redeemed for a financial or non-financial reward at a later time based on certain criteria. Reward 495 of points, miles, or other reward would be deposited into an end user reward account 496 designed to receive such rewards. Such a loyalty points reward system could be used in place of or in conjunction with a discount or other cash payment.

In a similar method, retailers could also receive loyalty points for the number of patients they register in the system, the number of products sold through the system, the value of products sold through the system or other such definable reward. Points accumulated in this manner could be redeemed for financial or non-financial rewards. It would also be possible to categorize retailers according to different tiers or levels and provide incentives in this manner.

For example, a retailer in the bronze tier may be compensated for 1% of the total value of the transaction whereas a retailer in the gold tier may be compensated for 2% of the total value of the transaction. Similarly, this method of tier-based reimbursement could be applied to the earning of loyalty points where, for example, the bronze retailer would make 1 point per purchase or similar and the gold retailer would make 3 points per purchase. Therefore the achievement of a reward would be accelerated in the case of a higher assigned tier level. Tier levels may be defined on the a variety of parameters some of which include geography, total value of transactions, total volume of transactions, total number of patients served, responsiveness, service quality, patient or other stakeholder reviews, level of importance, degree of influence, time spent with each patient, number of points accumulated in any given period of time, or any other such measure.

Similarly, physicians could also be assigned loyalty tiers and/or points along similar criteria.

Loyalty points could also be provided for market research responses fielded to retailers, physicians or patients.

Referring to FIG. 24, in some instances, it would be possible for the retailer 500 to send the system 507 with a text 503 with a request in a specific format 508 for deliveries of additional stock of specific medications. These may or may not include the campaign code 504. For example, if a retailer, low on stock of Brand X, were to text the system with the campaign code 504 plus a quantity of stock required 505, the system 507 would understand this request and deliver the request to another party such as a manufacturer 506 who could process and/or fulfill the order Similarly, it would be possible for the retailer or physician or patient to text the system with requests in a specific format for more information on the drug. For example, a retailer stocking a new drug may be able to text the system and receive information such as safety, efficacy, dosage, and pricing information. In some instances, it may be necessary to link two or more patient mobile phone numbers if a patient is no longer using an old mobile phone number which had been associated to Campaign IDs previously or is using more than one mobile phone at any given time. While the system may prompt the user to link mobile phones, the patient also would have the ability to link mobile phones by sending a pre-defined command to the system to link the phones. For example, a patient now using her new mobile phone, may text a command such as [link followed by her old number] to the system. The system would then link the two mobile phone numbers so that transactions could be tracked for the patient regardless of which phone is being used. This helps to create a unified patient history.

In some instances, it may be necessary to monitor the activity of stakeholders and send prompts when text messages sent to the system are low. For example, if Retailer XYZ does not send any patient registrations or no patients are texting in codes with Retailer XYZ's Pharmacy ID, the system would note such a lack of response and send automated reminder prompts via text message, phone call, interactive voice response, to encourage use of the system.

In some implementations, in order to aid in retailer or physician signup, the salesman or other party responsible for signing up the retailer or physician to participate in the system with respect to one or more of the campaigns or for other purposes, may wish to provide an in person demonstration (demo) to show the capabilities of the system, for example, in being able to send messages back quickly and accurately. In this demo, two mobile phones are required.

As shown in FIG. 25, in some implementations, the sales representative 510 will have a mobile phone 512 and the physician or retailer 514 will have a mobile phone 516. The demo involves the sales representative texting a specific demo keyword 518 followed by the retailer or physician's mobile phone number 520 to the system 522. The system will recognize this keyword and send previously defined messaging text 524 to both the sales representative's mobile phone and the physician or retailer's mobile phone. The message that is delivered may be customized based on the message recipient. It is also possible that prior to the demo, the mobile phone number of the sales representative has been entered into the system. Therefore, when a demo is conducted it is known which specific sales representative fielded the demo. This information is important for retailer or physician enrollment tracking.

As shown in FIG. 10, it will be possible to later connect the mobile phone number of the physician or the retailer for whom the demo was conducted to the final record for that physician or retailer once they have signed up. This way it is possible to understand the conversion metrics (that is the number of physicians or retailers who decide to participate as a percentage of the number of demonstrations given) from the time when a demo is made to the time when a physician or retailer signs up. It is also, therefore, possible to understand which responsible parties are the most efficient by looking at the conversion rates as well as the time to conversion. This data may also be used to define incentives for responsible parties.

Referring to FIGS. 29 and 30, in some instances, from time to time the system 650 may send questions 655 to patients 640 to obtain their health information. The system may prompt a patient to enter medical information 645 by SMS, text, or through some other interactive system 660 (IVR, telephone, or online, for example). For example, if a patient purchased a cholesterol medication, the system may ask him to enter his cholesterol levels, or a diabetes patient may be asked to enter her blood glucose levels. This information is linked to the patient's record and patient history.

Similar to the comorbidity, drug-drug interaction, and drug adherence/persistence results shown in FIGS. 12 and 13, the system also could also maintain and provide (as reports) similar health graphs tracking diagnostic results, levels, or other health outcomes. These reports 670 could be shared with the patient through the interactive system 660. Similarly, physicians or retailers 675 may have the ability to view this information as well. For example, a physician 675 could view the results 670 of her patients and track their blood glucose levels over time and potentially add in her own 677 information to this health record.

This requested information can be visualized using stakeholder-specific dashboards shown in FIGS. 31-34, customized for a patient, retailer, physician, and manufacturer. There four dashboards can be visualized online in a web portal or similar. Underscoring of items in the dashboards indicates that the items are clickable in order to see the data identified by those items. Similarly, simple SMS commands could be sent by stakeholders as queries 678 and 646 to retrieve specific data from the dashboards or the system. The dashboards represent data gathered from all the stakeholders interacting with the system.

The system could also provide tailored communications and information about a patient's medication, his diagnostic results, health outcomes, and the communications and information can benefit from and be based on knowledge of the patient's medication status and history, for instance. For example, a patient 640 who logs into the system could see his purchasing history, his physician and retailer information, his adherence and persistence values, his diagnostic results, levels or health outcomes and related information 670. For example, if the patient has purchased a hypertension drug, he may see his self-reported or physician-reported blood pressure levels over time and also see information on how to better manage his hypertension and to learn more about what hypertension is. Those who are poorly managed could therefore receive more support.

For a patient 640 to log in, the system could send a temporary password 680 to the patient's mobile phone. For example the patient's username could be his mobile number or other unique identifier. The patient may also need to confirm other information in order to enter their account.

Furthermore, once this information was amassed on a large scale, it would be available for potential biostatistics or epidemiological studies on the patient population, which could also be linked to patient pharmaceutical regimes and history. These data would include the percentage of the population with certain diseases, levels, and outcomes. This could be used for general public health purposes or could be provided to research institutions or pharmaceutical companies to perform health economics and cost-effectiveness studies.

All of the techniques, systems, implementations, and concepts discussed above have been described in the context of prescriptions for and dispensing of pharmaceuticals. They are also applicable to a wide variety of other medical products and services that can be prescribed, or can be dispensed, or can be bought or used by a patient, including medical devices. When we use the term pharmaceutical, we intend it broadly to include any such medical products and services.

Other implementations are within the scope of the following claims.

1. A computer-implemented method comprising
maintaining an association between a promotional campaign for a pharmaceutical product, and an identifier that is unique with respect to at least one of the campaign, the product, or a stakeholder associated with the product, and
storing, in association with the unique identifier, information about at least one of the following: the campaign, the product, the stakeholder, or activities of the stakeholder with respect to the product.

2. The method of claim 1 in which the stakeholder comprises at least one of an end user of the product, a physician who prescribes or recommends the product, a manufacturer of the product, or a retailer of the product.

3. The method of claim 1 in which the unique identifier is provided to a stakeholder who is an end user of the product.

4. The method of claim 3 in which the unique identifier is provided to the end user by the end user's physician or by a retailer that serves the end user or both.

5. The method of claim 1 in which information about the activities of the stakeholder is provided from a mobile device of the stakeholder.

6. The method of claim 1 in which information is stored, in association with the unique identifier, about activities of multiple stakeholders with respect to the product.

7. The method of claim 1 in which the unique identifier is associated with attributes of the associated campaign.

8. The method of claim 1 comprising analyzing the stored information with respect to the campaign.

9. The method of claim 8 comprising analyzing the stored information with respect to at least one other campaign.

10. The method of claim 1 comprising carrying out actionable attributes of the campaign.

11. The method of claim 10 in which the actionable attributes comprise at least one of customized communications, timed refill reminders, retailer rebates, or end user discounts.

12. The method of claim 1 comprising providing reports based on the stored information.

13. The method of claim 1 in which the information comprises responses of the stakeholder.

14. The method of claim 1 comprising sending messages to the stakeholder.

15. The method of claim 14 in which the messages comprise information including at least one of safety and efficacy of the product, affordability features of the product, discounts, promotions, coupons, rebates, medication adherence, education programs, and drug interactions.

16. The method of claim 14 in which the messages comprise customized communications or discounts that are based on relationships of the product to other products.

17. The method of claim 1 comprising tracking a sequence of activities with respect to the product.

18. The method of claim 17 in which the activities of the sequence include at least one of product recommendation or prescription by a physician, dispensing of the product to the end user, and use of the product by the end user.

19. The method of claim 7 in which the attributes comprise geography.

20. An apparatus comprising
a processor to maintain an association between a promotional campaign for a pharmaceutical product, and an identifier that is unique with respect to at least one of the campaign, the product, or a stakeholder associated with the product, and
storage to store, in association with the unique identifier, information about at least one of the following: the campaign, the product, the stakeholder, or activities of the stakeholder with respect to the product.

21. An apparatus comprising
means for maintaining an association between a promotional campaign for a pharmaceutical product, and an identifier that is unique with respect at least one of the campaign, the product, or a stakeholder associated with the product, and
means for storing, in association with the unique identifier, information about at least one of the following: the campaign, the product, the stakeholder, or activities of the stakeholder with respect to the product.

22. A computer-implemented method comprising
with respect to a promotional campaign for a pharmaceutical product, sending messages to mobile devices of stakeholders associated with the product, the messages being based on actionable attributes of the campaign and identified based on a unique identifier associated with the campaign.

23. The method of claim 1 in which a stakeholder can associate a mobile phone number belonging to the stakeholder with a campaign.

24. The method of claim 1 in which a stakeholder can associate a mobile phone number belonging to another stakeholder with a campaign.

25. The method of claim 3 in which the unique identifier provided to the end user is linked with a mobile number of the end user.

26. The method of claim 3 in which the unique identifier is provided to the end user verbally, on paper, or by an online system, interactive voice response program, or other computer assisted system.

27. The method of claim 1 in which information is stored by a stakeholder in association with a unique identifier associated with at least one of the end user's gender, age, address, physician's name, physician's location, or other demographic data.

28. The method of claim 27 in which the stakeholder enters the end user's information using a mobile phone, digital camera, or scanner and takes a photo or image of the end user's prescription and sends it to the system.

29. The method of claim 1 in which information is stored by a stakeholder in association with a unique identifier associated with at least one of a physician's company name, office name, mobile phone number or numbers, address, physician or other related stakeholder names, or sales representative or sales representative information.

30. The method of claim 14 in which the messages sent to a first stakeholder are sent on behalf of a second stakeholder.

31. The method of claim 30 in which the messages sent comprise an indicator that a second stakeholder is a source of the messages.

32. The method claim 1 comprising receiving indications that prescriptions have been filled for an end user.

33. The method of claim 32 in which the indications comprise at least one of a detailed invoice record, a registration card filled by the end user and kept by the retailer, or a part of the packaging being kept by the retailer.

34. The method of claim 32 in which the indications are associated with at least one of tracking a number of products or services that can be purchased at any given time or over a certain time period by an end user, restricting mobile numbers of retailers from purchase, or requiring a confirmation text from an end-user.

35. The method of claim 10 in which the actionable attribute comprises at least one of mobile minutes or airtime, loyalty points, miles, or other reward.

36. The method of claim 10 in which the actionable attribute is stored and acted on at a later time.

37. The method of claim 23 in which the mobile number is linked to one or more additional mobile numbers

38. The method of claim 1 in which the activity of stakeholders is monitored, and the stakeholder is sent an automated reminder prompt when messages sent to the system are low.

39. The method of claim 14 in which the messages comprise requests to purchase quantities of the product.

40. A method comprising
recording a number of visits made to physicians or retailers by sales representatives to solicit participation in a system in which an association is maintained between a promotional campaign for a pharmaceutical product and an identifier that is unique with respect to at least one of the campaign, the product, or a stakeholder associated with the product, and
storing, in association with the unique identifier, information about at least one of the following: the campaign, the product, the stakeholder, or activities of the stakeholder with respect to the product.

41. The method of claim 40 comprising tracking the number of physician or retailer enrollments into the system per sales representative.

42. The method of claim 1 in which an association is maintained between the promotional campaign and individual product labels containing unique product label codes.

43. The method of claim 10 in which the actionable attribute is in response to additional information supplied by a stakeholder.

44. The method of claim 36 in which the stored actionable attribute is delivered in response to a generated unique discount identifier.

45. The method of claim 1 in which information is stored by a stakeholder in association with an end user's mobile phone number associated with at least one of the end user's gender, age, address, physician's name, physician's location, or other demographic data.

46. The method of claim 1 in which information is stored by a stakeholder in association with an end user's mobile phone number associated with at least one of a physician's company name, office name, mobile phone number or numbers, address, physician or other related stakeholder names, or sales representative or sales representative information.

47. A method comprising
in a system in which an association is maintained between a promotional campaign for a pharmaceutical product and an identifier that is unique with respect to at least one of the campaign, the product, or a stakeholder associated with the product,
receiving information about a health status of an end user who is a participant in the promotional campaign and is using the pharmaceutical product and linking the received information to the end user's use of the pharmaceutical product.

48. The method of claim 47 in which the information received about the end user comprises laboratory results, diagnostic information, or health outcomes or any two or more of them.

49. The method of claim 47 comprising exposing to stakeholders in the promotional campaign graphical information and data reporting information received from the end user and information related to the end user's use of the pharmaceutical product.

50. The method of claim 49 in which the graphical information and data is exposed to the stakeholders through an SMS, text, IVR, telephone, or online interactive system.

51. The method of claim 47 in which the information is received from the end user.

52. The method of claim 47 in which the information is received from a stakeholder other than the end user.

53. The method of claim 47 in which the information is received in reply to queries from the system.
